(19) United States
(12) Patent Application Publication
(10) Pub. No.: US 2011/0296453 A1
(43) Pub. Date: Dec. 1, 2011

(54) Pay-Per-Website Visit ad system

(76) Inventors: Thirunarayanan Srinivasan, Highlands Ranch, CO (US); Ramesh Ramamurthy, Highlands Ranch, CO (US); Krishnan Kannan, Englewood, CO (US); Gopakumar Padmanabhan, Highlands Ranch, CO (US)

(21) Appl. No.: 12/790,972

(22) Filed: May 31, 2010

(51) Int. Cl. H04H 60/33

(52) U.S. Cl. 725/13

(57) ABSTRACT

A method and system are provided for correlating ads viewed on a Television through a Set-Top Box (STB) to subsequent website visits or online/mobile sale transactions in an anonymous manner. In accordance with one or more embodiments, the method includes the steps of (a) receiving from a STB the contents and ad runs, with the STB being identified by a STB ID; and (b) correlating the website visit or online/mobile sale transaction with identifiers such as IP Address and/or Unique Carrier User ID to the TV ad viewed by matching the STB ID based on two Advertisers with two different Ad IDs, one of which is a Local Ad, delivered to the same STB ID from two different Content IDs, and two visits by a user from the same IP Address to the respective URLs, both visits within a pre-determined time period after the respective ad runs.

### FIELD OF THE INVENTION

The present invention relates to a pay-per-website visit solution and, more particularly, to associating the website visit by a user to a TV ad seen by the same user, within a pre-determined time of the ad run, automatically and in an anonymous manner.

### BACKGROUND OF THE INVENTION

Advertisers promote products and services by running commercials in popular TV programs. Advertisers can measure the effectiveness of the TV commercials in many ways. One of the ways is to monitor their websites to analyze the traffic patterns. An increase in traffic to the website within a pre-determined time after the commercial's run in a TV channel is an indicator that the commercial has worked to raise the awareness of the Advertiser.

In the above method, however, there is no proof that associates a particular user's viewing of the TV commercial to the website visit made by the same user in an anonymous manner.

Ace Metrix's Ace Score is a patent-pending measurement of creative effectiveness based on measures of persuasion and watchability, and delivered by the on-demand Ace Metrix service. The persuasion rating is based on the interactivity of six data elements, namely, desire, relevance, likeability, attention, information and change, automatically captured and analyzed for each ad. The term watchability measures the engagement that a person has with the ad.

The Ace Score's does not associate a specific user that watched the TV ad to the website within a pre-determined time of the ad run in an anonymous manner. It would be advantageous to provide proof that each ad impression can result in no more than one chargeable lead.

It would be advantageous to charge a fee based on the sale amount of transaction as well.

It would also be advantageous to provide proof of user's ad watched that led to the website visit that may eventually result in a sale transaction.

It would further be advantageous to provide a detailed ROI report.

### SUMMARY OF THE INVENTION

A method and system are provided for connecting a Set-Top Box (STB) that delivers TV ads to a user and subsequent website visits by the same user to either gather more information regarding the advertised product/service or make a purchase in an anonymous manner. In accordance with one or more embodiments, the method includes the steps of (a) receiving from a Multiple System Operator (MSO) and storing the one or more contents and TV ads watched by a user with the help of a STB; (b) identifying the contents through one or more TV programs through identifiers such as Content IDs; (c) identifying TV ads, shown as part of one or more contents, with Ad IDs, along with their ad run times, from merchants that signed up with the Service Provider as Advertisers; (d) identifying the website visits by the user through identifiers such as IP Address (applies to online visits) or Carrier User ID (applies to mobile phone visits); (e) associating the STB ID to the IP Address or Carrier User ID of the user based on two different TV Ad IDs, one of which is a Local TV Ad, delivered to the same STB ID from two different Content IDs and two different Advertisers, and two different website visits by the user from the same IP Address or Carrier User ID to the respective Advertisers' URLs, both visits within a pre-determined time period after the respective ad run times; (f) charging the selected Advertiser a fee for the website visit or purchase made by the user at the website based on the sale amount; and (g) providing detailed Return-On-Investment reports to the Advertiser and Service Provider.

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a pay-per-website visit ad system showing entity-relationship diagram;

FIG. 2 is a perspective view of a pay-per-website visit ad system receiving and storing tv ads from advertisers;

FIG. 3 is a perspective view of a pay-per-website visit ad system associating the website visit to the tv ad viewed;

FIGS. 4A, 4B, 4C, 4D, 4E, 4F, and 4G are an exploded view of a pay-per-website visit ad system storing the data in tv ad server db tables;

FIG. 5A is an exploded view of a tv data server receiving various data feeds from the ads server and service provider server;

FIG. 5B is an exploded view of a tv data server receiving various data feeds from the service provider server;

FIG. 6 is an exploded view of a tv data server receiving one or more website visits or sale transactions from one or more advertisers' web servers;

FIG. 7A is an exploded view of a tv data server executing the correlation logic associating the website visit or sale transaction to the tv ad viewed;

FIG. 7B is an exploded view of a correlation logic of the pay-per-website visit ad system associating the website visit or sale transaction to the tv ad viewed;

FIG. 7C is an exploded view of a correlation logic of the pay-per-website visit ad system associating the website visit or sale transaction to the tv ad viewed;

FIG. 7D is an exploded view of a correlation logic of the pay-per-website visit ad system associating the website visit or sale transaction to the tv ad viewed;

FIG. 7E is an exploded view of a correlation logic of the pay-per-website visit ad system associating the website visit or sale transaction to the tv ad viewed; and

FIG. 8 is an exploded view of an advertiser viewing the reports.

For purposes of clarity and brevity, like elements and components will bear the same designations and numbering throughout the Figures.

### DESCRIPTION OF THE PREFERRED EMBODIMENT

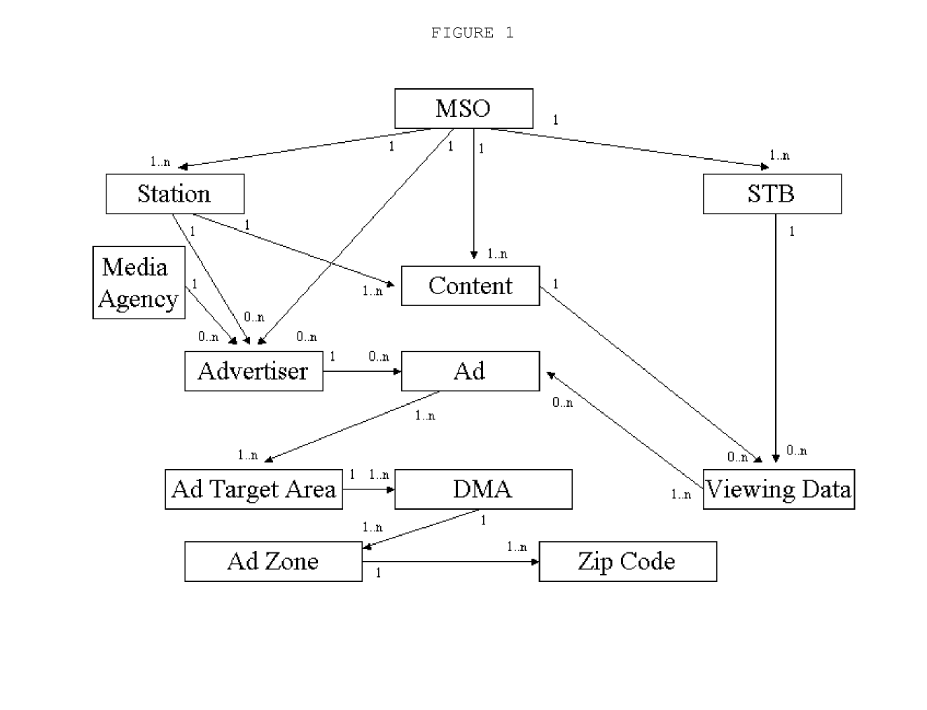

FIG. 1 is a perspective view of Pay-Per-Website Visit ad system showing a entity-relationship diagram, in accordance with the invention. A Multiple System Operator (MSO) has one or more stations 302. Each station broadcasts one or more contents 306. Contents 306 also can be broadcast by the MSO. The MSO serves one or more Set-Top Boxes (STBs 304).

An Advertiser 110 may be signed up by a MSO, station, and/or Advertising Agency. A user 100 may view the content through the STB. An Advertiser 110 may run many Pay-Per-Website Visit (PPWV) Ads, each of which will be viewed by the user 100 through the STB. Each PPWV Ad may be targeted at one or more areas, each of which contains one or more DMAs. Each DMA contains one or more ad zones and each ad zone contains one or more zip codes.

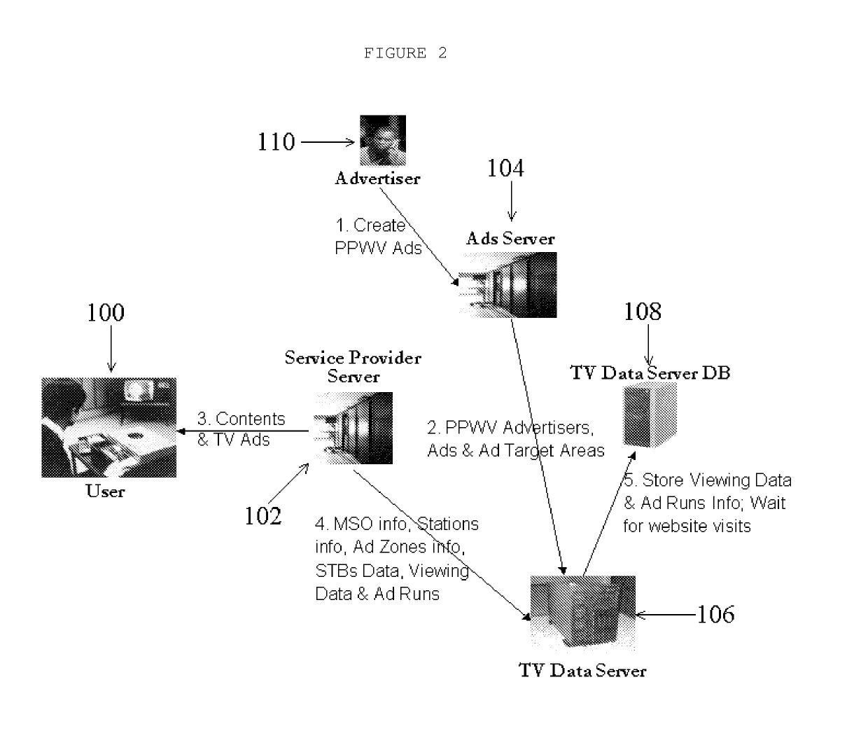

FIG. 2 is a perspective view of Pay-Per-Website Visit ad system receiving and storing TV ads from Advertisers, in accordance with the invention. An Advertiser 110 creates an account in the Ads Server 104. The Advertiser 110 may create one or more ads for one or more products/services in the Ads Server 104. Each ad is targeted at one or more areas and is broadcast as part of a specific content. The Ads Server 104 sends the Advertiser 110, the ads and the target areas details to TV Data Server 108.

The Service Provider may be a MSO, station, or a 3rd party vendor like Nielsen, Rentrak, and comScore that license the STB data from the MSOs. The Service Provider Server 102 sends reference data for such elements as MSO, stations 302, and ad zones to the TV Data Server 108. On a daily basis, the Service Provider Server 102 sends data about one or more STBs 304, including additions and deletions, to the TV Data Server 108. In addition, the Service Provider Server 102 sends data about one or more content viewings done through one or more STBs 304, as well as the actual ad run times of the various ads to the TV Data Server 108. All the data sets are stored in the TV Data Server 108 database. The Ads Server 104, Service Provider Server 102, and TV Data Server 108 consist of one or more computers interconnected in a data center and hosted either inside or outside the firewall of the MSO, station, or a 3rd party vendor.

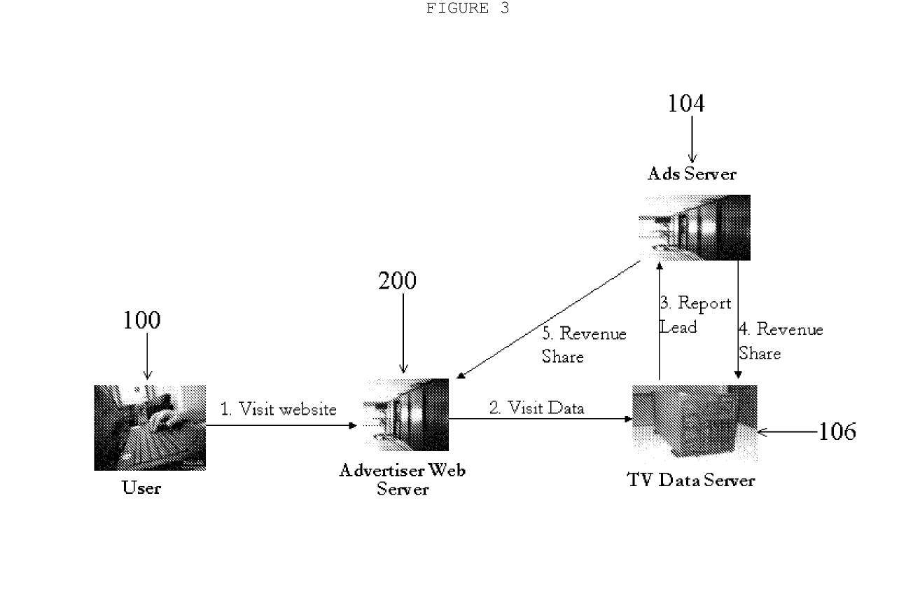

FIG. 3 is a perspective view of Pay-Per-Website Visit ad system associating the website visit to the TV ad viewed, in accordance with the invention. The user 100 visits the website of one or more Advertiser 110 URLs. The Web Server of the Advertiser 110 captures the unique visitors information and passes the same to TV Data Server 108, which in turn executes the Correlation Logic to determine the association between the website visit or online/mobile sale transaction and the TV ad viewed in an anonymous manner as described below. If the association is established, then the TV Data Server 108 reports a lead to the Ads Server 104, which in turn charges the Advertiser 110 the lead fee. Ads Server 104 then returns the partner's revenue share of the lead fee to the TV Data Server 108.

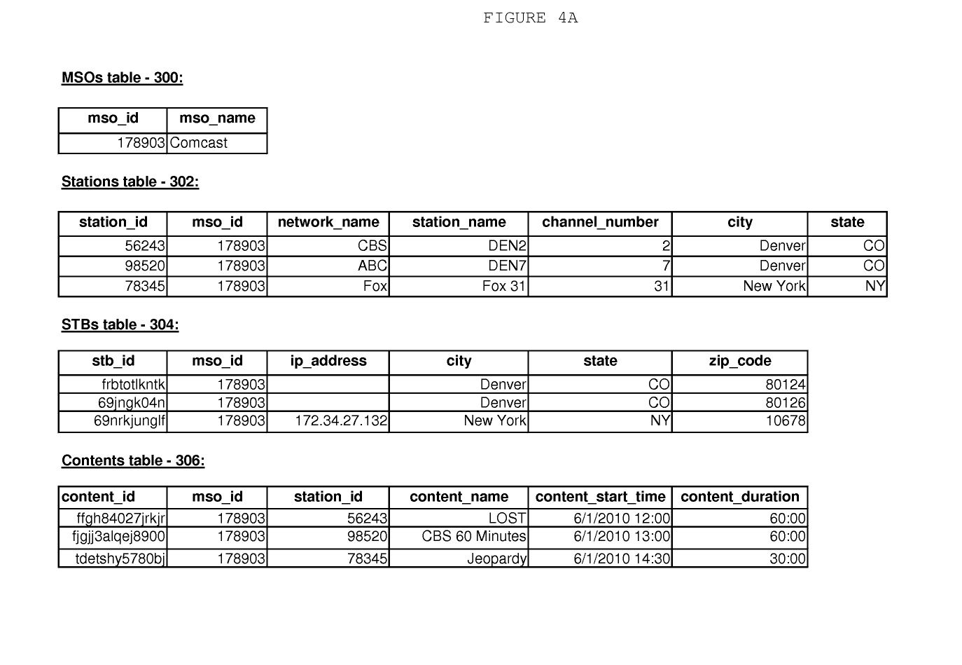

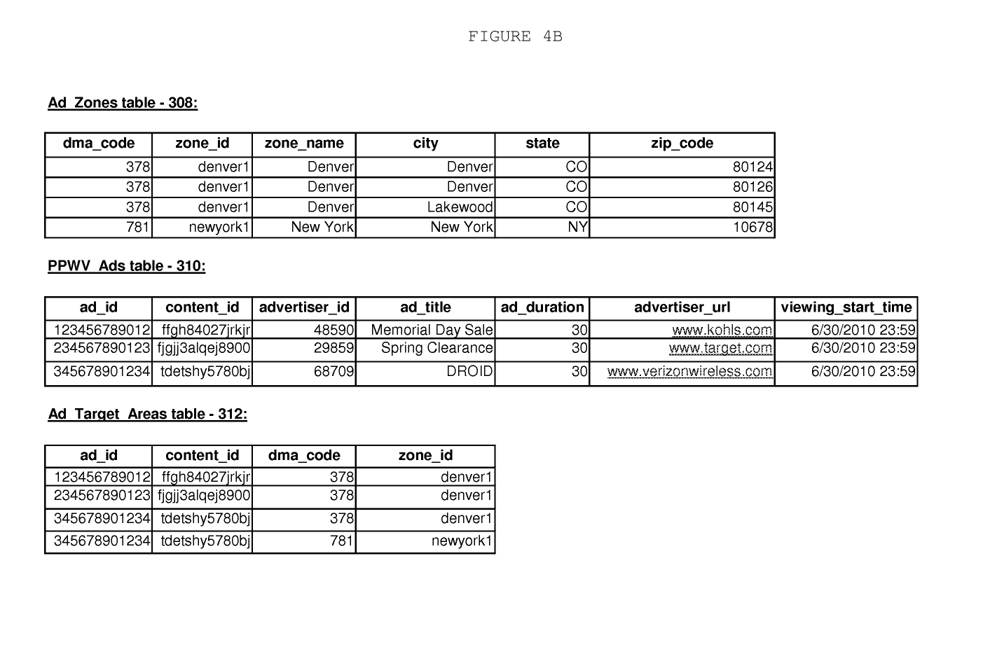

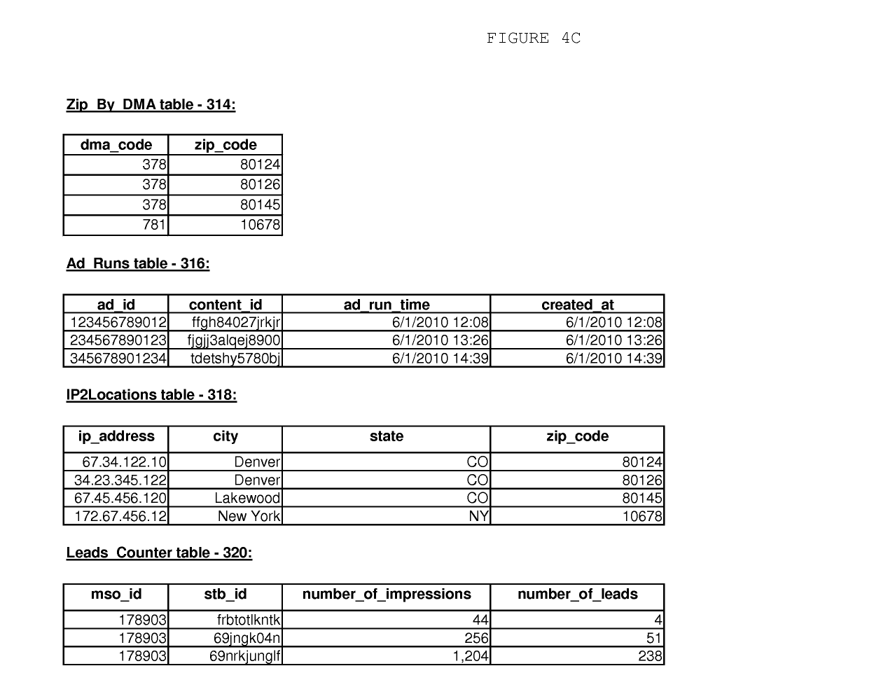

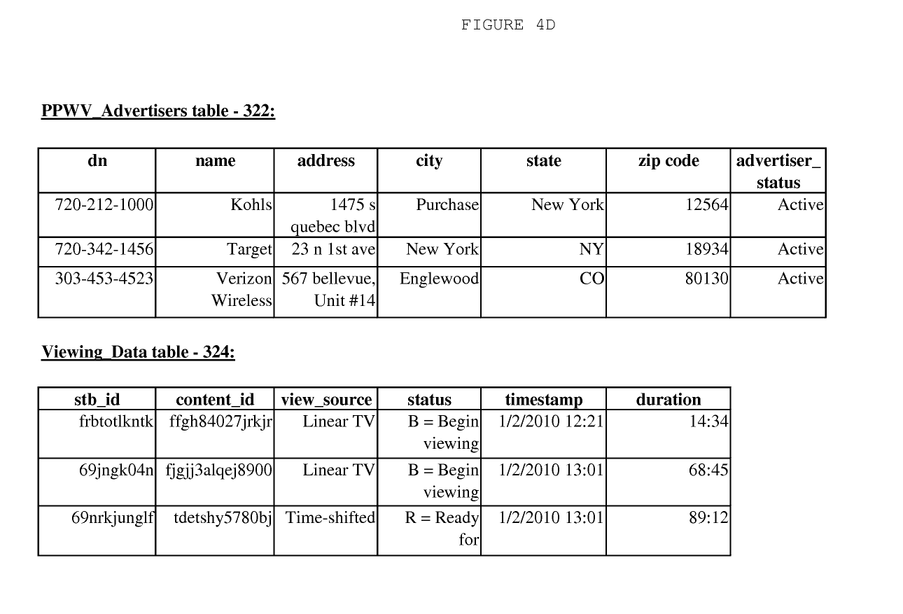

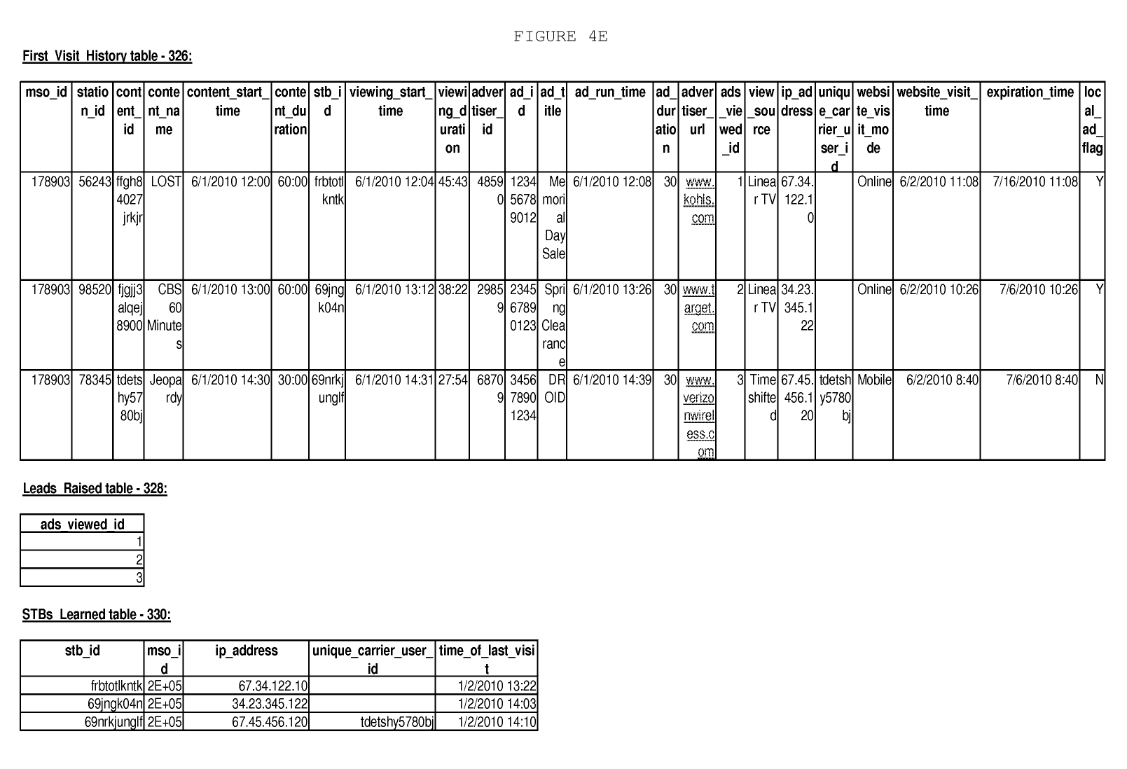

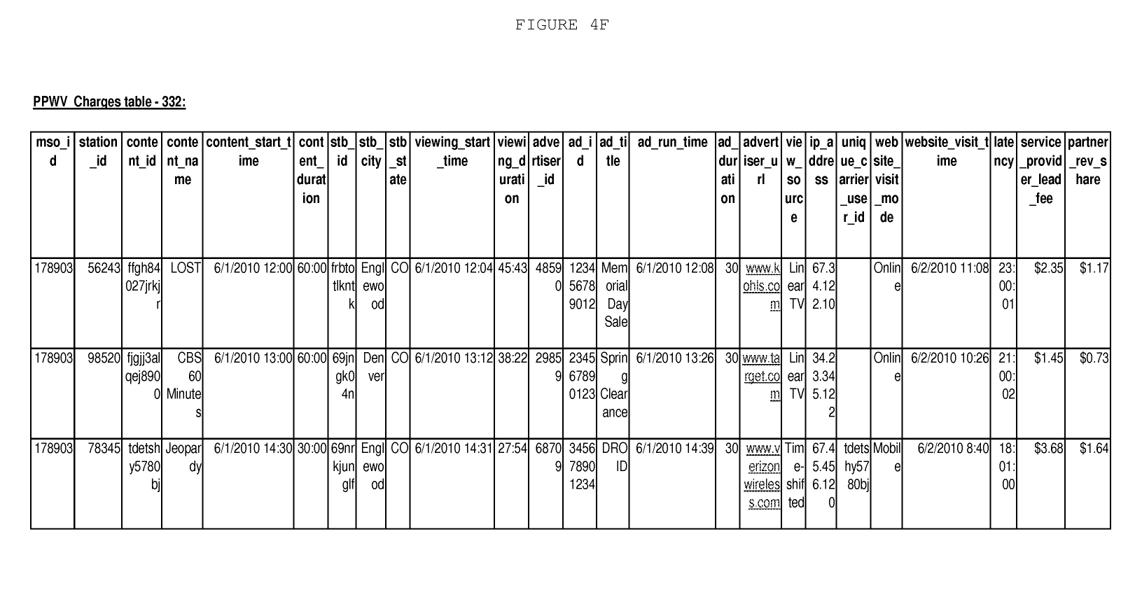

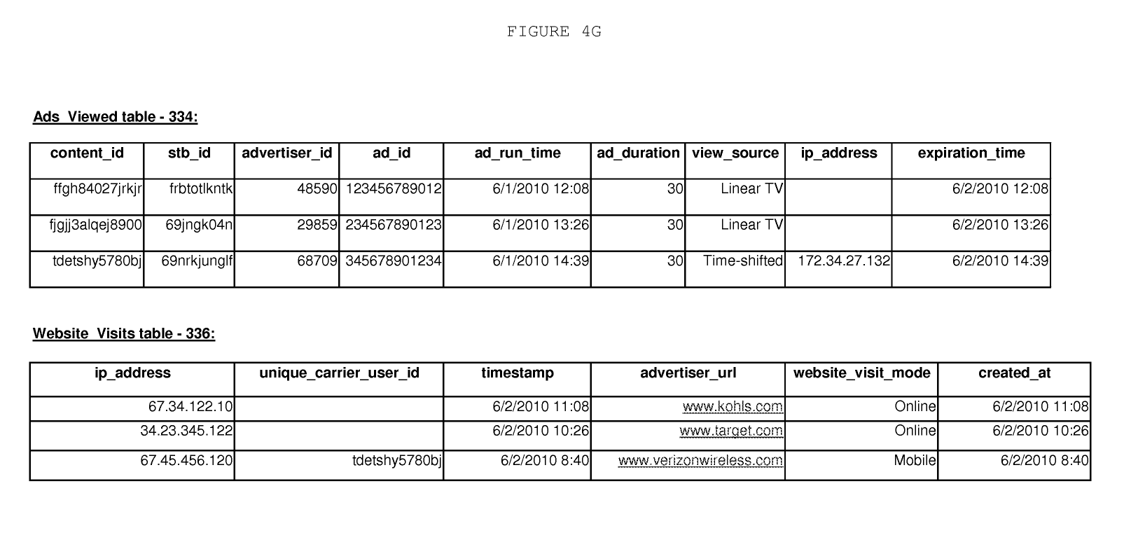

FIGS. 4A, 4B, 4C, 4D, 4E, 4F, and 4G are an exploded view of the database tables schema, in accordance with the invention. It should be noted that the tables described may or may not reside within TV Data Server 108. The database consists of one or more computers interconnected in a data center running popular databases like Oracle, My*SQL, or SQL Server and maybe contained in the TV Data Server 108.

The database will have reference data pre-loaded into the IP2Locations 318 and Zip_By_DMA 314 tables. More specifically, the IP2Locations 318 table gives a mapping of the IP Address to its city, state, and zip code. This table will be loaded with data available from many vendors, including www.Ip2Location.com. The columns of this table include: ip_address, city, state, and zip_code. The Zip_By_DMA 314 table gives a mapping of the Zip Code to the Designated Marketing Area (DMA). The term DMA is defined by Nielsen, Inc. and is used in TV advertising. DMA Codes specify one or more US counties for TV advertising. The Zip_By_DMA 314 table will be loaded with the data available from Nielsen. The columns of this table include: zip_code and dma.

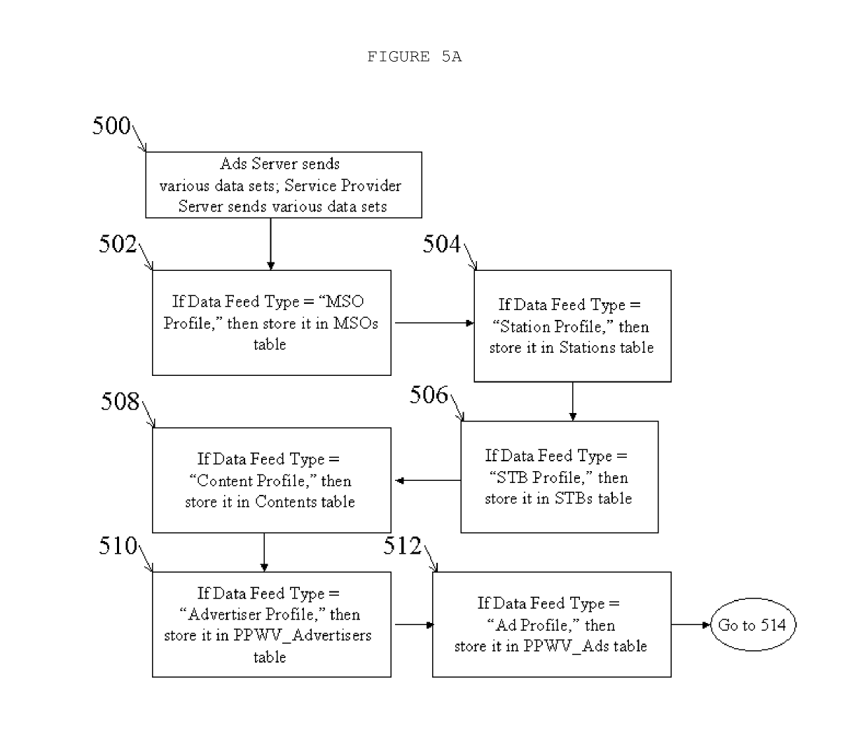

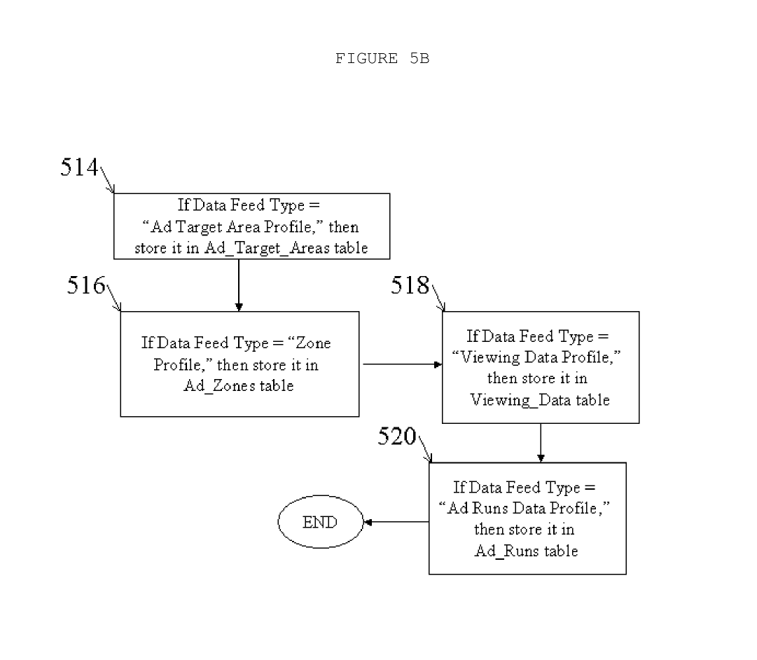

FIGS. 5A and 5B are an exploded view of the TV Data Server 108 receiving various data feeds from the Ads Server 104 and Service Provider Server 102, in accordance with the invention. In FIG. 5A, step 500, the TV Data Server 108 receives various data feeds from Ads Server 104 and TV Data Server 108.

More specifically, in step 502 TV Data Server 108 receives the “MSO Profile” from the Service Provider Server 102 and stores it in the MSOs table. The columns of the MSOs table include: mso_name (like Comcast, at&t Uverse, DISH, DirecTV) and mso_id. In step 504, TV Data Server 108 receives the “Station Profile” from the Service Provider Server 102 and stores it in the Stations 302 table. The “Station Profile” comprises one or more stations 302 served by the MSO. The columns of the Stations 302 table include: station_id, mso_id, network_name (Optional; like CBS, CBS Sports, CBS Biz), station_name, channel_number (like Weather Channel, Channel 7 affiliated to CBS), city, and state. In step 506, TV Data Server 108 receives the “STB Profile” from the Service Provider Server 102 on a daily basis and stores it in the STBs 304 table. The “STB Profile” comprises one or more STBs 304 served by the MSO. The columns of the STBs 304 table include: stb_id, ip_address (newer STBs 304 have Wireless capability so as to give 100% Correlation), mso_id, city, state, zip_code, and delete_flag (default is N). The feed includes both additions and deletions of STBs 304 served by the MSO. In step 508, TV Data Server 108 receives the “Content Profile” from the Service Provider Server 102 and stores it in the Contents 306 table. The “Contents 306 Profile” comprises one or more contents 306 broadcast by the MSO. Typically, contents 306 are the same information that the user 100 could view by pressing the TV Guide button on the remote control of the TV set and are known a week ahead of their scheduled runs. The columns of the Contents 306 table include: content_id, mso_id, station_id, content_name (like CBS 60 Minutes, ABC News), start_time, and duration (in secs).

In step 510, TV Data Server 108 receives the “Advertiser 110 Profile” from the Ads Server 104 and stores it in the PPWV_Advertisers 322 table. The “Advertiser 110 Profile” comprises one or more advertisers that have signed up for the PPWV advertising model. The columns of the PPWV_Advertisers 322 table include: name, dn, address, city, state, zip_code, and advertiser_status (Active & Inactive). In step 512, TV Data Server 108 receives the “Ad Profile” from the Ads Server 104 and stores it in the PPWV_Ads 310 table. The “Ad Profile” comprises one or more PPWV ads that have been configured by the Advertiser 110. The columns of the PPWV_Ads 310 table include: ad_id, content_id, advertiser_id, ad_title, duration (in secs), advertiser_url, and final_ad_broadcast_time. In FIG. 5B, step 514, TV Data Server 108 receives the “Ad Target Area Profile” from the Ads Server 104 and stores it in the Ad_Target_Areas 312 table. The “Ad Target Area Profile” comprises one or more target areas that have been configured by the Advertiser 110 for the ad. The columns of the Ad_Target_Areas 312 table include: ad_id, content_id, dma_code, and zone_id. In step 516, TV Data Server 108 receives the “Zone Profile” from the Service Provider Server 102 and stores it in the Ad_Zones 308 table. The “Zone Profile” comprises one or more ad zones that have been configured by the Service Provider. The columns of the Ad_Zones 308 table include: dma_code, zone_id, zone_name, city, state, and zip_code.

When an Advertiser 110 terminates the account, the Ads Server 104 sends a message to TV Data Server 108, which will set the advertiser_status column to Inactive in the PPWV_Advertisers 322 table.

In step 518, TV Data Server 108 receives the “Viewing Data Profile” from the Service Provider Server 102 and stores it in the Viewing_Data 324 table. The “Viewing Data Profile” comprises one or more records of TV viewings through one or more STBs 304. The columns of the Viewing_Data 324 table include: stb_id, content_id, view_source (L=Linear TV, T=Time-shifted, and V=VOD), status (B=Begin viewing, E=End viewing, R=Ready for processing), timestamp, and duration. The Service Provider Server 102 can detect when the user 100 begins to view a specific content and passes a record of it to the TV Data Server 108. TV Data Server 108 creates a record in the Viewing_Data 324 table. TV Data Server 108 determines whether or not the stb_id exists in one or more records of the STBs_Learned 330 table. If not, then TV Data Server 108 updates the expiration_time of one or more records of the First_Visit_History 326 table for the matching stb_id with a value equal to the timestamp+pre-determined time period. The reason for updating the expiration_time is that it gives more number of days to learn the STB per the Correlation Logic defined below. Later, when the user 100 changes the channel number on the remote control, the Service Provider Server 102 passes a record of it to the TV Data Server 108 to denote the end of viewing of the channel, followed by another record to denote the beginning of viewing on the new channel number. If, on the other hand, the user 100 switches off the TV set but leaves the STB powered on, then the Service Provider Server 102 may not receive the end of viewing event immediately. In such situations, the Service Provider Server 102 has methods to detect inactivity on the STB and automatically generates the end of viewing event and passes an event to the TV Data Server 108. TV Data Server 108 locates the corresponding record in the Viewing_Data 324 table and marks the status column as R=Ready for processing. TV Data Server 108 also updates the duration column of the same record with the elapsed time of viewing by the user 100 via the specific STB.

In step 520, TV Data Server 108 receives the “Ad Runs Profile” from the Service Provider Server 102 and stores it in the Ad_Runs 316 table. The “Ad Runs Profile” comprises one or more records of PPWV ads' times broadcast to all the STBs 304 by the MSO. The columns of the Ad_Runs 316 table include: ad_id, content_id, timestamp, and created_at.

A process in TV Data Server 108 runs at pre-determined time intervals and runs through each of the records in the Viewing_Data 324 and Ad_Runs 316 tables and executes the following steps.

1. Create records in the Ads_Viewed 334 table if the one or more ads are viewed by one or more stb_id based on matching content_id values in the Ad_Runs 316, Viewing_Data 324, PPWV_Ads 310, and Contents 306 tables, and matching stb_id values in the Viewing_Data 324 and STBs 304 tables, and matching ad_id values in the Ad_Runs 316 and PPWV_Ads 310 tables, and matching advertiser_id values in the PPWV_Advertisers 322 and PPWV_Ads 310 tables.

2. For each record created in the Ads_Viewed 334 table, increment the number of impressions in the Leads_Counter table.

3. Purge the corresponding records in the Viewing_Data 324 and Ad_Runs 316 tables that match the set of records per Item 1 above.

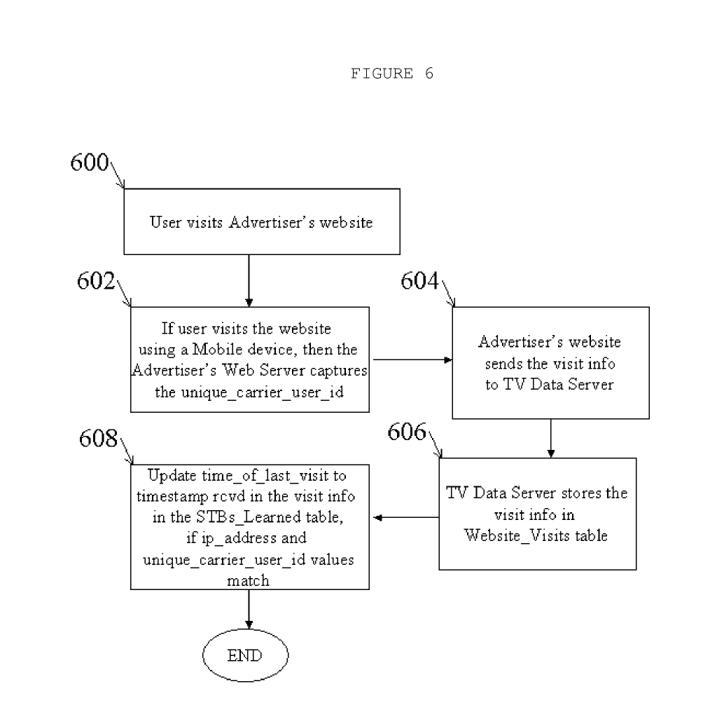

FIG. 6 is an exploded view of the TV Data Server 108 receiving one or more website visits or online/mobile sale transactions from one or more Advertisers' web servers, in accordance with the invention. It should be noted that the user 100 may visit the website of the Advertiser 110 as soon as the ad was aired while the corresponding ad run time is reported by the Service Provider Server 102 a while later. Therefore, the TV Data Server 108 needs to store the website visits or online/mobile sale transactions and then correlate them to the ads viewed through a process that runs at pre-determined intervals. In step 600, when the user 100 visits the website of the Advertiser 110, the web server is required to capture only unique visitors information and pass it onto the TV Data Server 108. The user 100 may use a desktop, laptop, or mobile phone to visit the Advertiser 110 website. Accordingly in steps 602 through 606, the Advertiser 110 web server is required to capture the visit information and pass them to TV Data Server 108. The message includes such parameters as ip_address, unique_carrier_user_id (applies only to mobile devices), advertiser_url, website_visit_mode (Online or Mobile), and timestamp, which are then stored in the Website_Visits 336 table. The unique_carrier_user_id can be derived from the Wireless Access Protocol (WAP) message received by the WAP Server of the Advertiser 110. Alternatively, the Advertiser 110 also may use software from such companies as Bango, Inc. (called Bango Unique User ID) and/or RingLeader, Inc. (called MediaStamp) to obtain the unique_carrier_user_id for each mobile device. If the website_visit_mode=Online, then the web server sends a NULL value in the unique_carrier_user_id parameter. In step 608, TV Data Server 108 updates the time_of_last_visit column, provided a match exists in one or more records of the STBs_Learned 330 table based on the ip_address and unique_carrier_user_id.

In another embodiment of the invention, if the ip_address of the user 100 is considered to be sensitive information, then the Service Provider may issue a key with which the Advertiser 110 can encrypt it before passing it onto TV Data Server 108. The encryption is based on the MD5 algorithm, and so once encrypted the value cannot be decrypted by anyone, including the sender. In yet another embodiment of the invention, if the stb_id, city, state, and zip_code of the STB is considered to be sensitive information, then the Service Provider may use the same key to encrypt the data before passing onto TV Data Server 108. However, for the Correlation Logic to work properly, the Service Provider is also required to encrypt the ip_address, city, state, and zip_code data loaded into the IP2Locations 318 table with the same key.

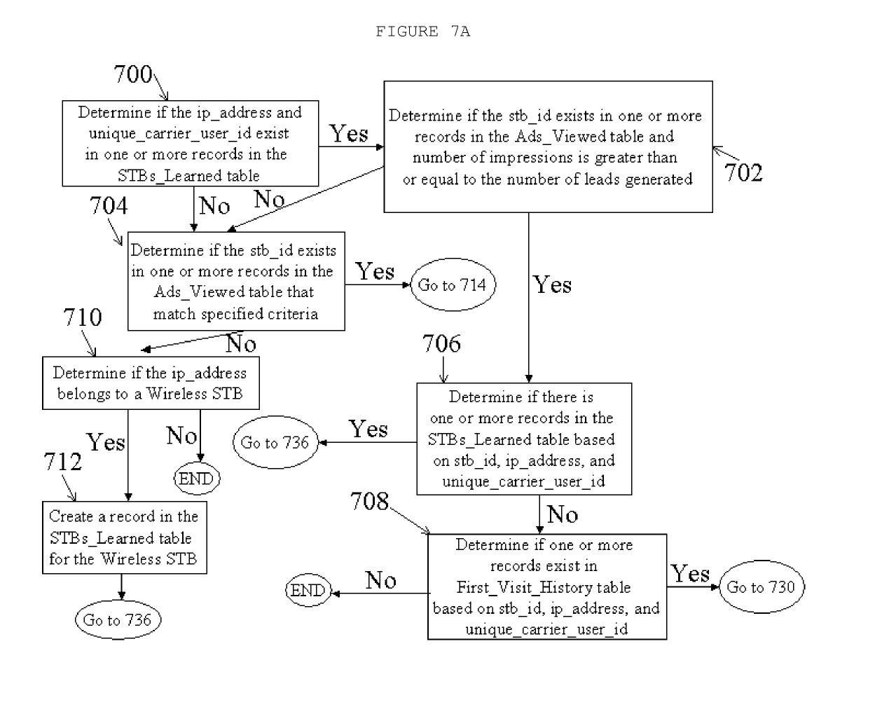

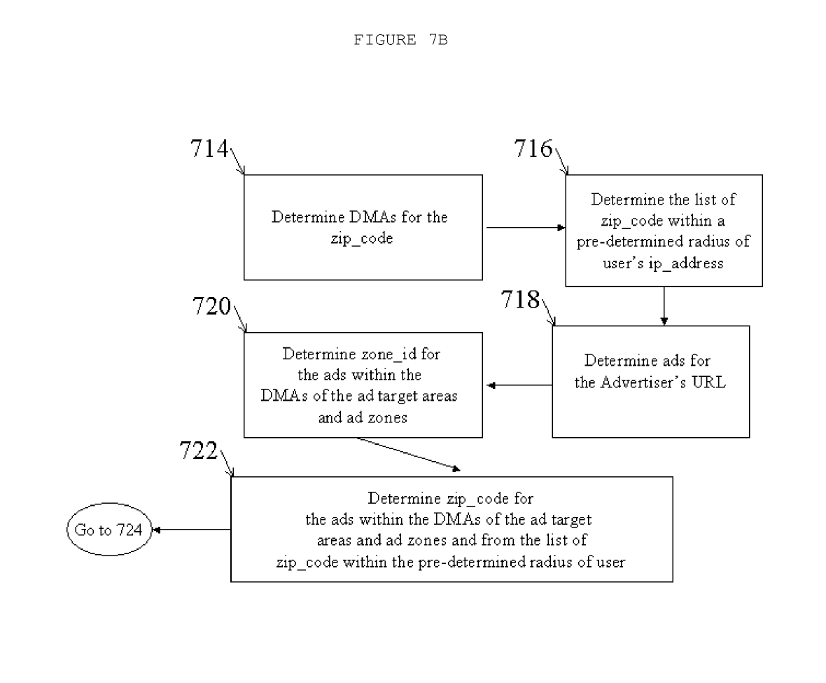

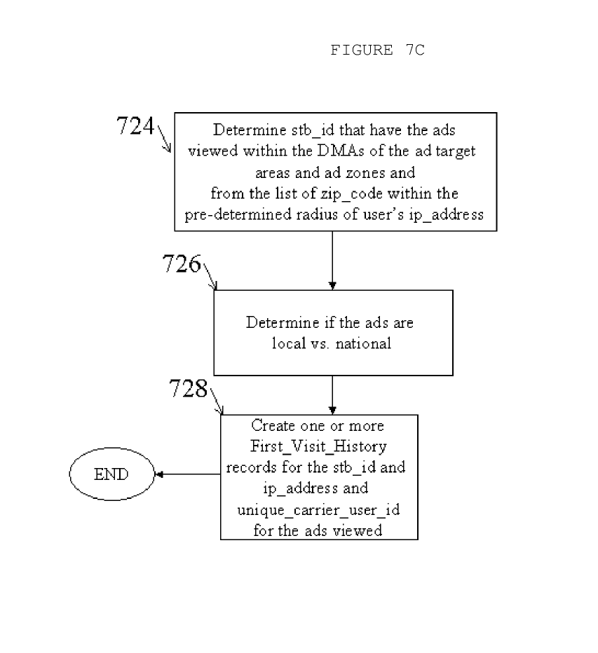

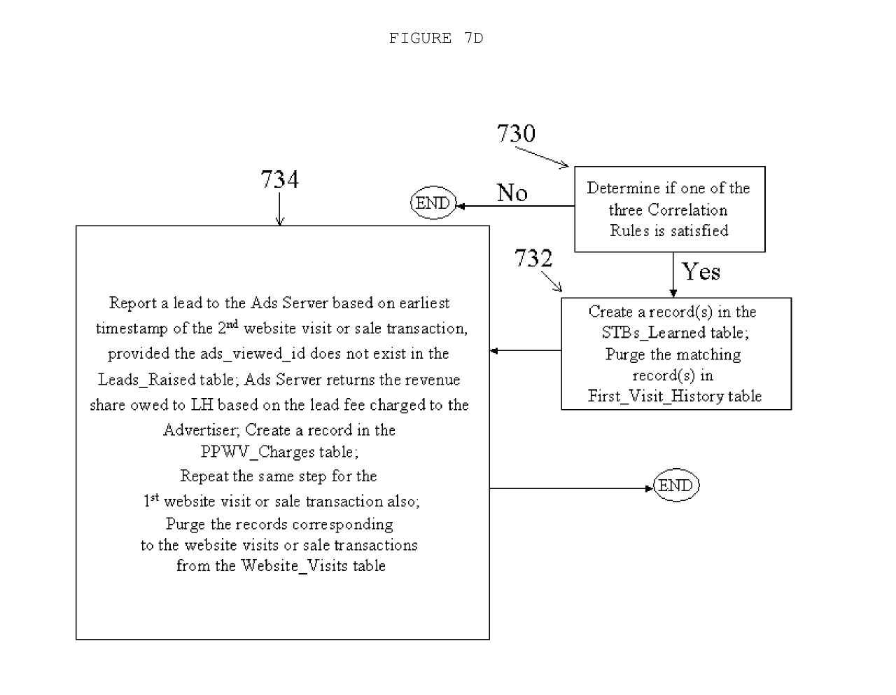

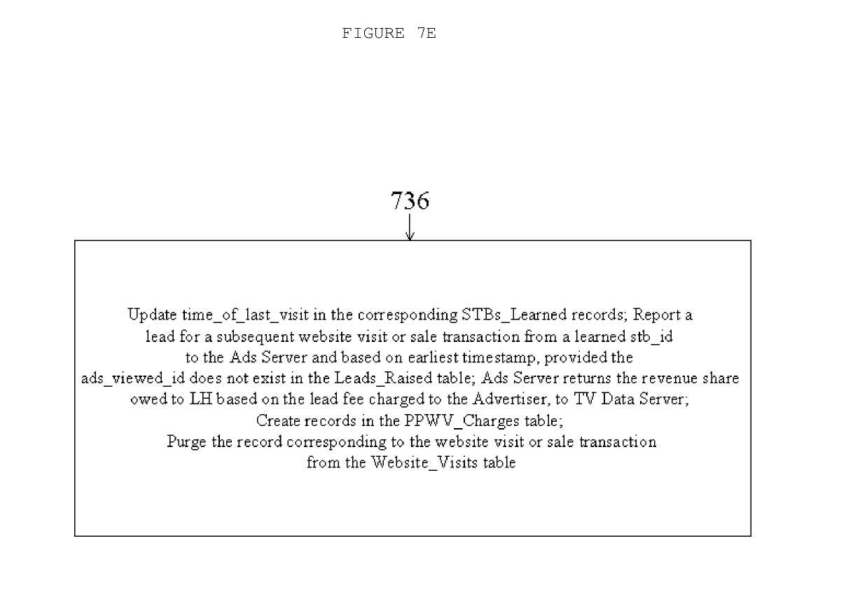

FIGS. 7A, 7B, 7C, 7D, and 7E are an exploded view of the TV Data Server 108 executing the Correlation Logic associating the website visit or online/mobile sale transaction to the TV ad viewed, in accordance with the invention.

More specifically, a process in the TV Data Server 108 selects one or more records from the Website_Visits 336, IP2Locations 318, and Ads_Viewed 334 tables such that timestamp value in the Website_Visits 336 record is greater than or equal to the value in the Ads_Viewed 334 record and less than or equal to the value in the Ads_Viewed 334 record and the ip_address in the Website_Visits 336 record is equal to the ip_address value in the IP2Locations 318 record.

The process then runs through each of the “selected” records determined in the above paragraph. More specifically, in FIG. 7A, step 700 the Correlation Logic determines if the ip_address and unique_carrier_user_id exist in one or more records in the STBs_Learned 330 table. If records exist, in step 702 the Correlation Logic determines if the stb_id exists in the said one or more records in the Ads_Viewed 334 table and number of impressions is greater than or equal to the number of leads generated. If no records exist, then in step 704 the Correlation Logic determines if the said stb_id exists in the said one or more records in the Ads_Viewed 334 table and number of impressions is greater than or equal to the number of leads generated. If no records exist, the Correlation Logic proceeds to step 714 as explained below. If records exist, in step 710 the Correlation Logic determines if the said ip_address belongs to a Wireless STB by ensuring that the said ip_address in the said “selected” record matches with the said ip_address value in the Ads_Viewed 334 table and the number of records in the Ads_Viewed 334 table=1 and the said unique_carrier_user_id in the said “selected” record=NULL. If conditions in the previous sentence match and if the said stb_id does not exist in the STBs_Learned 330 table already, in step 712 the Correlation Logic creates a record in the STBs_Learned 330 table.

In step 706, the Correlation Logic determines if there is one or more records in the

STBs_Learned 330 table based on the said stb_id, ip_address, and unique_carrier_user_id. If records exist, the Correlation Logic proceeds to step 738 as explained below. If no records exist, in step 708 the Correlation Logic determines if one or more records exist in First_Visit_History 326 table based on the said stb_id, ip_address, and unique_carrier_user_id. If records exist, the Correlation Logic proceeds to step 730 as explained below.

In FIG. 7B, step 714, the Correlation Logic determines one or more DMAs for the said zip_code in the said “selected” record. In step 716, the Correlation Logic determines the list of zip_code within a pre-determined radius of the said ip_address in the said “selected” record. In step 718, the Correlation Logic determines one or more ads for the said advertiser_url in the said “selected” record. In step 720, the Correlation Logic determines one or more zone_id for the said ads within the said DMAs of the said ad target areas and ad zones. In step 722, the Correlation Logic determines one or more zip_code for the said ads within the said DMAs of the said ad target areas and the said one or more ad zones and from the said list of zip_code within the pre-determined radius of user 100. In FIG. 7C, step 724, the Correlation Logic determines one or more stb_id that have the said ads viewed within the said DMAs of the said ad target areas and said ad zones and from the said list of zip_code within the pre-determined radius of the said ip_address in the said “selected” record. In step 726, the Correlation Logic determines if the said one or more ads are local vs. national based on the said number of DMAs is less than or equal to a pre-determined number of DMAs and the said number of ad zones is less than or equal to a pre-determined number of ad zones. In step 728, the Correlation Logic creates one or more First_Visit_History 326 records for the said one or more stb_id and ip_address and unique_carrier_user_id for the said ads viewed.

In step 730, the Correlation Logic determines if one of the three Correlation Rules specified below is satisfied by comparing the said “selected” record values against the said one or more matching records of the First_Visit_History 326 table per step 708.

1. Two Advertisers with two different ad_id, one of which is a Local Ad, delivered to the same stb_id from two different content_id, and two visits by a user 100 from the same ip_address and optionally the same unique_carrier_user_id (applies to mobile only) to the respective URLs, both visits within a pre-determined time period after the respective ad runs.

2. An Advertiser 110 with two different ad_id, one of which is a Local Ad, delivered to the same stb_id from two different content_id, and two visits by a user 100 from the same ip_address and optionally the same unique_carrier_user_id (applies to mobile only) to the respective URLs, both visits within a pre-determined time period after the respective ad runs.

3. Two Advertisers with two different ad_id, one of which is a Local Ad, delivered to the same stb_id from the same content_id that are at least a pre-determined time apart, and two visits by a user 100 from the same ip_address and optionally the same unique_carrier_user_id (applies to mobile only) to the respective URLs, both visits within a pre-determined time period after the respective ad runs.

In FIG. 7D, step 732, the Correlation Logic creates one or more records in the STBs_Learned 330 table, purges the matching said records in the First_Visit_History 326 table. In step 734, the Correlation Logic reports a lead to the Ads Server 104 based on the earliest said timestamp value in the said “selected” record of the said 2nd website visit or online/mobile sale transaction, provided the ads_viewed_id does not exist in the Leads_Raised 328 table. Ads Server 104 returns the revenue share owed to the partner based on the lead fee charged to the Advertiser 110 to TV Data Server 108. The Correlation Logic then creates a record in the PPWV_Charges 332 table. Then, Correlation Logic repeats step 734 for the said 1st website visit or online/mobile sale transaction also.

In FIG. 7E, step 736, the Correlation Logic updates the time_of_last_visit in the corresponding STBs_Learned 330 record with the said timestamp value in the said “selected” record. Then, the Correlation Logic reports a lead for a said subsequent website visit or online/mobile sale transaction from a said learned std_id to the Ads Server 104 based on the earliest said timestamp value in the said “selected” record of the website visit or online/mobile sale transaction, provided the ads_viewed_id does not exist in the Leads_Raised 328 table. Ads Server 104 returns the revenue share owed to the partner based on the lead fee charged to the Advertiser 110 to TV Data Server 108. The Correlation Logic then creates a record in the PPWV_Charges 332 table.

A scheduled process running in TV Data Server 108 will purge records in the First_Visit_History 326 table, provided the expiration_time is greater than current time. In addition, another scheduled process running in TV Data Server 108 will purge records in the STBs_Learned 330 table, provided the current time is greater than the time_of_last_visit+a predetermined value. Another scheduled process running in the TV Data Server 108 will purge records in the PPWV_Ads 310 and Ad_Target_Areas 312 tables, provided the current time is greater than the final_ad_broadcast_time in the corresponding PPWV_Ads 310 record. Yet another scheduled process running in the TV Data Server 108 will purge records in the Ads_Viewed 334 table with expiration_time greater than current time.

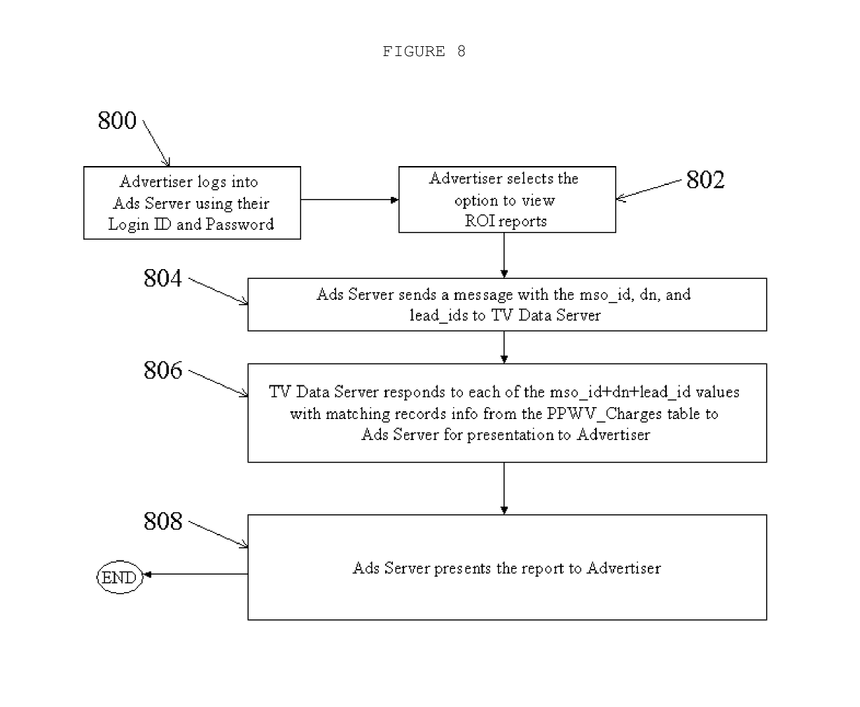

FIG. 8 is an exploded view of the Advertiser 110 viewing the ROI reports, in accordance with the invention. In step 800, the Advertiser 110 logs into their account with the Ads Server 104 using their Login ID and Password. In step 802, the Advertiser 110 selects the option to view the PPWV ROI reports. In step 804, the Ads Server 104 sends a message with the mso_id, dn, and one or more lead ids to TV Data Server 108. The said one or more lead ids were earlier reported to the Ads Server 104 when the Correlation Logic raised leads to the Advertiser 110 for the said one or more ads viewed based on the said one or more website visits or online/mobile sale transactions.

In step 806, TV Data Server 108 responds to each of the mso_id+dn+lead_id values with parameters corresponding to a record from the PPWV_Charges 332 table to Ads Server 104. In step 808, the Ads Server 104 presents the report to the Advertiser 110.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A pay-per-website visit ad system for providing proof that the website visit is associated to a tv ad and in an anonymous manner, comprising:
means for viewing one or more contents, each of which contains one or more tv ads, delivered to a stb; and making a website visit to either gather information on product/service advertised or make a purchase;
means for creating an account in the service provider's ads server; creating one or more ppwv campaigns under the account; getting charged a lead fee for one or more website visits or online/mobile purchase transactions based on the one or more ads that the user viewed as part of the one or more tv programs per the correlation logic; and having the privilege to view the roi report;
means for creating one or more pay-per-website visit advertisers consisting of name, address, city, state, zip code, and directory number (dn); maintaining one or more pay-per-website visit (ppwv) tv ads configured by the advertiser; sending one or more ppwv advertisers and their respective tv ads details to the tv data server; determining the lead fee applicable to a website visit or online/mobile sale transaction as reported by the tv data server; and sharing the lead fee with the partner;
means for receiving relevant one or more tv contents and associated ads from the serving system and delivering them to one or more set-top boxes (stbs); sending one or more stbs information consisting of stb id, ip address (optional, newer stbs have wireless capability), mso id, city, state, and zip code to tv data server; passing one or more viewing data consisting of stb id, content id, view source (l=linear tv, t=time-shifted, and v=vod), status (b=begin viewing, e=end viewing), and timestamp to tv data server; and sending one or more ad runs information consisting of ad id, content id, and timestamp to tv data server;
means for storing one or more stations that are served by the said mso that maybe affiliated to one or more networks having one or more channel numbers;
means for storing one or more stbs served by the said mso, including those that are to be dropped because of subscriber disconnects from the said mso, with an ip_address if the said stb is wireless capable, where the ip_address is assigned by the internet service provider (isp) of the subscriber and is the same for tv viewing and internet browsing;
means for storing one or more contents broadcast by the said mso via the said one or more stations having the said one or more channel numbers;
means for storing one or more zones under the said one or more dmas, where each zone contains one or more zip codes;
means for storing the said one or more zip codes within the said one or more dmas;
means for storing one or more ip_address against the city, state, and zip_code;
means for storing one or more ppwv advertisers' information that signed up with the ads server running at a service provider;
means for storing one or more ppwv ads that are scheduled to run as part of the said one or more contents with the content_id, advertiser_id, duration, ad_title, advertiser_url, and final_ad_broadcast_time as configured by the one or more ppwv advertisers in the said ads server;
means for storing one or more target areas for the said one or more ppwv ads that are broadcast as part of the said one or more contents within the said one or more dmas, each of which contains the said one or more zones, which in turn contain the said one or more zip codes;
means for receiving the mso information from the service provider server and storing the information in the msos table; receiving one or more stations served by the said mso from the said service provider server and storing the information in the stations table; receiving one or more ad zones served by the said mso from the said service provider server and storing the information in the ad_zones table; receiving one or more stbs, including additions and deletions, served by the said mso from the said service provider server and storing the information in the stbs table; receiving one or more ppwv advertisers from an ads server and storing the information in the ppwv_advertisers table; receiving one or more ppwv ads, and one or more zone ids related to the said one or more ppwv advertisers from the said ads server and storing the information in the ppwv_ads and ad_target_areas tables, respectively; receiving one or more program-related contents that are broadcast through the cable tv network or satellite tv network from the said service provider server and storing the information in the contents table; receiving one or more viewing data information relating to the said one or more contents delivered to one or more users' said stbs by the said mso from the said service provider server and storing the information in the viewing_data table; receiving one or more ad runs information relating to the said one or more ppwv ads by the said mso from the said service provider server and storing the information in the ad_runs table; determining and creating one or more ads viewed relating to the said one or more ppwv ads that are watched as part of the said one or more contents and delivered to the said one or more stbs by the said mso from the said service provider server and storing the information in the ads_viewed table; receiving one or more users' online and mobile website visits information from one or more ppwv advertisers' web servers and storing the information in the website_visits table; executing correlation logic to a) determine the records containing city, state, and zip_code from the ip2locations table for the one or more ip_address stored in the said website_visits table, provided the website visit time in the said records is greater than or equal to the ad run time and less than or equal to the expiration time in the said one or more records of the ads_viewed table; b) for each record in the said website_visits table, determine one or more dma_code from the zip_by_dma table based on the said zip_code in the ip2locations record; c) generate a list of zip codes that are within a pre-determined radius of the said zip_code in the said ip2locations record; d) determine one or more ppwv ads from the said ppwv_ads table for the said one or more ppwv advertisers in active status and for the advertiser_url in the said website_visits record; e) determine further one or more ppwv ads that are broadcast within the said one or more zone_id in the said ad_target_areas table based on a match of the ad_id and content_id, as well as dma_code in the said ad_target_areas table vs. the dma_code found in the said zip_by_dma table; f) determine further the one or more said ppwv ads that are broadcast within the said one or more zip_code for the said one or more zone_id; g) determine further the one or more ppwv ads that are broadcast within the said one or more zip_code for the said one or more zone_id and within the list of the said zip_code in a pre-determined radius of the said zip_code in the said ip2locations record; h) determine further the count of unique said dma_code for the said zip_code in the said ip2locations record; i) determine further the count of unique said zone_id for the said one or more said ppwv ads that are broadcast within the one or more said zip_code for the one or more said zone_id and within the list of said zip_code in the pre-determined radius of the said zip_code in the said ip2locations record; j) determine further that the unique count of the said dma_code and the unique count of the said zone_id constitute a local ad based on the count of the unique said dma_code being less than or equal to a pre-determined number of dma zones and the unique count of the said zone_id being less than or equal to a pre-determined number of ad zones; k) determine further that the said one or more ppwv ads delivered to the one or more stb_id are within the said one or more zip_code and that the said zip_code for the said one or more zone_id are within the said list of zip_code in a pre-determined radius of the said zip_code in the said ip2locations record and that the said website visit occurred within a pre-determined time period of the said ad runs and that a lead fee has not been already been raised for the one or more records in the said ads_viewed table; l) determine further that the resulting said one or more ppwv ads is due to the 1st website visit from the said ip_address; m) store the resulting said one or more ppwv ads in the first_visit_histories table; n) update the existing one or more records in the said first_transaction_histories table with expiration_time equal to the timestamp of the said one or more records of the said viewing_data records+a pre-determined time period, if the said stb_id matches between the said one or more viewing_data and first_visit_histories tables' records; o) learn the stb on the 2nd website visit by associating the said ip_address and optionally unique_carrier_user_id (applies only to mobile devices) with the said one or more stb_id and creating one or more records in the stbs_learned table, each with an expiration_time set equal to the website_visit_time of the said 2nd visit, based on two different ad_id, one of which is the said local ad, delivered to the same said stb_id from two different content_id and two different advertisers, and two visits by a user from the same said ip_address and optionally the same unique_carrier_user_id (applies to mobile devices) to the respective urls, both visits within a pre-determined time period after the respective said ad runs, by ensuring that the said 2nd website visit is from the same said ip_address as that present in the one or more records of the said first_visit_histories table, and the said records of the first_transaction_history table containing the same said stb_id value as that present in the one or more records of the said ads_viewed table, and the said records of the first_transaction_history table and the said one or more records of the ads_viewed table containing two different content_id and two different ad_id values with one of them being the said local ad with local_ad_flag=yes from two different advertiser_id; p) learn the stb on the 2nd website visit by associating the said ip_address and optionally unique_carrier_user_id (applies only to mobile devices) with the said one or more stb_id and creating one or more records in the stbs_learned table, each with an expiration_time set equal to the website_visit_time of the said 2nd visit, based on two different ad_id, one of which is the said local ad, delivered to the same said stb_id from two different content_id and the same said ppwv advertiser, and two visits by a user from the same said ip_address and optionally the same unique_carrier_user_id (applies to mobile devices) to the respective urls, both visits within a pre-determined time period after the respective said ad runs, by ensuring that the said 2nd website visit is from the same said ip_address as that present in the said one or more records of the first_visit_histories table, and the said records of the first_transaction_history table containing the same said stb_id value as that present in the said one or more records of the ads_viewed table, and the said records of the first_transaction_history table and the said one or more records of the ads_viewed table containing two different content_id and two different ad_id values with one of them being the said local ad with local_ad_flag=yes from the same advertiser_id; q) learn the stb on the 2nd website visit by associating the said ip_address and optionally unique_carrier_user_id (applies only to mobile devices) with the said one or more stb_id and creating the one or more records in the stbs_learned table, each with an expiration_time set equal to the website_visit_time of the said 2nd visit, based on two different ad_id that are at least a pre-determined time period apart in respect of their said ad run times, one of which is the said local ad, delivered to the same said stb_id from the same content_id and two different said ppwv advertisers, and two visits by a user from the same said ip_address and optionally the same unique_carrier_user_id (applies to mobile devices) to the respective urls, both visits within a pre-determined time period after the respective said ad runs, by ensuring that the said 2nd website visit is from the same said ip_address as that present in one or more records of the said first_visit_histories table, and the said records of the first_transaction_history table containing the same said stb_id value as that present in the said one or more records of the ads_viewed table, and the said records of the first_transaction_history table and the said one or more records of the ads_viewed table containing the same content_id and two different ad_id values with one of them being the said local ad with local_ad_flag=yes from two different advertiser_id; r) learn the stb on the 1st website visit by associating the ip_address with the one stb_id and creating one record in the stbs_learned table, with an expiration_time set equal to the website_visit_time of the said 1st visit, based on an ad_id associated to a content_id and delivered to a wireless stb_id that shares the same said ip_address for both tv viewing and computer usage in the household, and a visit by the user from the same said ip_address to the said ppwv advertiser's url within a pre-determined time period after the said ad run, by ensuring that the said 1st website visit is from the same said ip_address as that present in the one and only one record of the said ads_viewed table; s) raise one or more leads for the ads viewed for the said 1st and/or 2nd website visits or online/mobile sale transactions to the said ads_server when a said stb is learned or when the one or more subsequent website visits or online/mobile sale transactions is applied from an already learned said stb if the website visits came from the same said ip_address and optionally the same unique_carrier_user_id (applies to mobile devices), based on the earliest timestamp of one of the records of the said ads_viewed table while ensuring that the number of leads for the said stb_id is less than or equal to the number of ad impressions and that there is no more than one lead for an impression of the ad by verifying that the said record of the ads_viewed table is not already present in the leads_raised table; and t) create one or more records in the ppwv_charges table with the lead fee and revenue share received from the said ads server; and facilitating the viewing of the roi report by one or more authorized employees of the said mso and one or more said ppwv advertisers;
means for storing one or more contents viewed by the said one or more stb_id, including the time of viewing and the view_source like linear tv, time-shifted, or video-on-demand (vod);
means for storing one or more ppwv ads viewed through stbs by one or more users as part of one or more contents, each with a pre-determined expiration time;
means for storing the said one or more ppwv ads broadcast to all the said stbs as part of the said one or more contents;
means for storing one or more unique users visiting the website or making a sale transaction from desktop and mobile devices, as reported by the one or more ppwv advertisers' web servers;
means for storing one or more 1st website visits or sale transactions as determined by the correlation logic; and updating the expiration time of the said one or more records of the first_visit_history table when the said one or more records of viewing_data are received from the service provider server for the matching stb_id;
means for storing one or more stbs learned against the said one or more ip_address and unique_carrier_user_id per the said correlation logic; updating one or more existing records for the time_of_last_visit when the one or more new website visits or online/mobile sale transactions are received based on a match of the ip_address and unique_carrier_user_id values in the stbs_learned table;
means for storing one or more leads raised by the said correlation logic so as to ensure that no more than no more than one lead is raised for an impression of the ppwv ad for the said stb_id served by the said mso; and
means for storing one or more valid leads, associated with the said one or more stb_id as well as the said one or more ip_address and unique_carrier_user_id for the said one or more website visits or online/mobile sale transactions per the said correlation logic.

2. The pay-per-website visit ad system in accordance with claim 1, wherein said means for viewing one or more contents, each of which contains one or more tv ads, delivered to a stb; and making a website visit to either gather information on product/service advertised or make a purchase comprises an user.

3. The pay-per-website visit ad system in accordance with claim 1, wherein said means for creating an account in the service provider's ads server; creating one or more ppwv campaigns under the account; getting charged a lead fee for one or more website visits or online/mobile purchase transactions based on the one or more ads that the user viewed as part of the one or more tv programs per the correlation logic; and having the privilege to view the roi report comprises an advertiser.

4. The pay-per-website visit ad system in accordance with claim 1, wherein said means for creating one or more pay-per-website visit advertisers consisting of name, address, city, state, zip code, and directory number (dn); maintaining one or more pay-per-website visit (ppwv) tv ads configured by the advertiser; sending one or more ppwv advertisers and their respective tv ads details to the tv data server; determining the lead fee applicable to a website visit or online/mobile sale transaction as reported by the tv data server; and sharing the lead fee with the partner comprises an ads server.

5. The pay-per-website visit ad system in accordance with claim 1, wherein said means for receiving relevant one or more tv contents and associated ads from the serving system and delivering them to one or more set-top boxes (stbs); sending one or more stbs information consisting of stb id, ip address (optional, newer stbs have wireless capability), mso id, city, state, and zip code to tv data server; passing one or more viewing data consisting of stb id, content id, view source (l=linear tv, t=time-shifted, and v=vod), status (b=begin viewing, e=end viewing), and timestamp to tv data server; and sending one or more ad runs information consisting of ad id, content id, and timestamp to tv data server comprises a service provider server.

6. The pay-per-website visit ad system in accordance with claim 1, wherein said means for storing one or more stations that are served by the said mso that maybe affiliated to one or more networks having one or more channel numbers comprises a stations.

7. The pay-per-website visit ad system in accordance with claim 1, wherein said means for storing one or more stbs served by the said mso, including those that are to be dropped because of subscriber disconnects from the said mso, with an ip_address if the said stb is wireless capable, where the ip_address is assigned by the internet service provider (isp) of the subscriber and is the same for tv viewing and internet browsing comprises a stbs.

8. The pay-per-website visit ad system in accordance with claim 1, wherein said means for storing one or more contents broadcast by the said mso via the said one or more stations having the said one or more channel numbers comprises a contents.

9. The pay-per-website visit ad system in accordance with claim 1, wherein said means for storing one or more zones under the said one or more dmas, where each zone contains one or more zip codes comprises an ad_zones.

10. The pay-per-website visit ad system in accordance with claim 1, wherein said means for storing the said one or more zip codes within the said one or more dmas comprises a zip_by_dma.

11. The pay-per-website visit ad system in accordance with claim 1, wherein said means for storing one or more ip_address against the city, state, and zip_code comprises an ip2locations.

12. The pay-per-website visit ad system in accordance with claim 1, wherein said means for storing one or more ppwv advertisers' information that signed up with the ads server running at a service provider comprises a ppwv_advertisers.

13. The pay-per-website visit ad system in accordance with claim 1, wherein said means for storing one or more ppwv ads that are scheduled to run as part of the said one or more contents with the content_id, advertiser_id, duration, ad_title, advertiser_url, and final_ad_broadcast_time as configured by the one or more ppwv advertisers in the said ads server comprises a ppwv_ads.

14. The pay-per-website visit ad system in accordance with claim 1, wherein said means for storing one or more target areas for the said one or more ppwv ads that are broadcast as part of the said one or more contents within the said one or more dmas, each of which contains the said one or more zones, which in turn contain the said one or more zip codes comprises an ad_target_areas.

15. The pay-per-website visit ad system in accordance with claim 1, wherein said means for receiving the mso information from the service provider server and storing the information in the msos table; receiving one or more stations served by the said mso from the said service provider server and storing the information in the stations table; receiving one or more ad zones served by the said mso from the said service provider server and storing the information in the ad_zones table; receiving one or more stbs, including additions and deletions, served by the said mso from the said service provider server and storing the information in the stbs table; receiving one or more ppwv advertisers from an ads server and storing the information in the ppwv_advertisers table; receiving one or more ppwv ads, and one or more zone ids related to the said one or more ppwv advertisers from the said ads server and storing the information in the ppwv_ads and ad_target_areas tables, respectively; receiving one or more program-related contents that are broadcast through the cable tv network or satellite tv network from the said service provider server and storing the information in the contents table; receiving one or more viewing data information relating to the said one or more contents delivered to one or more users' said stbs by the said mso from the said service provider server and storing the information in the viewing_data table; receiving one or more ad runs information relating to the said one or more ppwv ads by the said mso from the said service provider server and storing the information in the ad_runs table; determining and creating one or more ads viewed relating to the said one or more ppwv ads that are watched as part of the said one or more contents and delivered to the said one or more stbs by the said mso from the said service provider server and storing the information in the ads_viewed table; receiving one or more users' online and mobile website visits information from one or more ppwv advertisers' web servers and storing the information in the website_visits table; executing correlation logic to a) determine the records containing city, state, and zip_code from the ip2locations table for the one or more ip_address stored in the said website_visits table, provided the website visit time in the said records is greater than or equal to the ad run time and less than or equal to the expiration time in the said one or more records of the ads_viewed table; b) for each record in the said website_visits table, determine one or more dma_code from the zip_by_dma table based on the said zip_code in the ip2locations record; c) generate a list of zip codes that are within a pre-determined radius of the said zip_code in the said ip2locations record; d) determine one or more ppwv ads from the said ppwv_ads table for the said one or more ppwv advertisers in active status and for the advertiser_url in the said website_visits record; e) determine further one or more ppwv ads that are broadcast within the said one or more zone_id in the said ad_target_areas table based on a match of the ad_id and content_id, as well as dma_code in the said ad_target_areas table vs. the dma_code found in the said zip_by_dma table; f) determine further the one or more said ppwv ads that are broadcast within the said one or more zip_code for the said one or more zone_id; g) determine further the one or more ppwv ads that are broadcast within the said one or more zip_code for the said one or more zone_id and within the list of the said zip_code in a pre-determined radius of the said zip_code in the said ip2locations record; h) determine further the count of unique said dma_code for the said zip_code in the said ip2locations record; i) determine further the count of unique said zone_id for the said one or more said ppwv ads that are broadcast within the one or more said zip_code for the one or more said zone_id and within the list of said zip_code in the pre-determined radius of the said zip_code in the said ip2locations record; j) determine further that the unique count of the said dma_code and the unique count of the said zone_id constitute a local ad based on the count of the unique said dma_code being less than or equal to a pre-determined number of dma zones and the unique count of the said zone_id being less than or equal to a pre-determined number of ad zones; k) determine further that the said one or more ppwv ads delivered to the one or more stb_id are within the said one or more zip_code and that the said zip_code for the said one or more zone_id are within the said list of zip_code in a pre-determined radius of the said zip_code in the said ip2locations record and that the said website visit occurred within a pre-determined time period of the said ad runs and that a lead fee has not been already been raised for the one or more records in the said ads_viewed table; l) determine further that the resulting said one or more ppwv ads is due to the 1st website visit from the said ip_address; m) store the resulting said one or more ppwv ads in the first visit_histories_table; n) update the existing one or more records in the said first_transaction_histories table with expiration_time equal to the timestamp of the said one or more records of the said viewing_data records+a pre-determined time period, if the said stb_id matches between the said one or more viewing_data and first_visit_histories tables' records; o) learn the stb on the 2nd website visit by associating the said ip_address and optionally unique_carrier_user_id (applies only to mobile devices) with the said one or more stb_id and creating one or more records in the stbs_learned table, each with an expiration_time set equal to the website_visit_time of the said 2nd visit, based on two different ad_id, one of which is the said local ad, delivered to the same said stb_id from two different content_id and two different advertisers, and two visits by a user from the same said ip_address and optionally the same unique_carrier_user_id (applies to mobile devices) to the respective urls, both visits within a pre-determined time period after the respective said ad runs, by ensuring that the said 2nd website visit is from the same said ip_address as that present in the one or more records of the said first_visit_histories table, and the said records of the first_transaction_history table containing the same said stb_id value as that present in the one or more records of the said ads_viewed table, and the said records of the first_transaction_history table and the said one or more records of the ads_viewed table containing two different content_id and two different ad_id values with one of them being the said local ad with local_ad_flag=yes from two different advertiser_id; p) learn the stb on the 2nd website visit by associating the said ip_address and optionally unique_carrier_user_id (applies only to mobile devices) with the said one or more stb_id and creating one or more records in the stbs_learned table, each with an expiration_time set equal to the website_visit_time of the said 2nd visit, based on two different ad_id, one of which is the said local ad, delivered to the same said stb_id from two different content_id and the same said ppwv advertiser, and two visits by a user from the same said ip_address and optionally the same unique_carrier_user_id (applies to mobile devices) to the respective urls, both visits within a pre-determined time period after the respective said ad runs, by ensuring that the said 2nd website visit is from the same said ip_address as that present in the said one or more records of the first_visit_histories table, and the said records of the first_transaction_history table containing the same said stb_id value as that present in the said one or more records of the ads_viewed table, and the said records of the first_transaction_history table and the said one or more records of the ads_viewed table containing two different content_id and two different ad_id values with one of them being the said local ad with local_ad_flag=yes from the same advertiser_id; q) learn the stb on the 2nd website visit by associating the said ip_address and optionally unique_carrier_user_id (applies only to mobile devices) with the said one or more stb_id and creating the one or more records in the stbs_learned table, each with an expiration_time set equal to the website_visit_time of the said 2nd visit, based on two different ad_id that are at least a pre-determined time period apart in respect of their said ad run times, one of which is the said local ad, delivered to the same said stb_id from the same content_id and two different said ppwv advertisers, and two visits by a user from the same said ip_address and optionally the same unique_carrier_user_id (applies to mobile devices) to the respective urls, both visits within a pre-determined time period after the respective said ad runs, by ensuring that the said 2nd website visit is from the same said ip_address as that present in one or more records of the said first_visit_histories table, and the said records of the first_transaction_history table containing the same said stb_id value as that present in the said one or more records of the ads_viewed table, and the said records of the first_transaction_history table and the said one or more records of the ads_viewed table containing the same content_id and two different ad_id values with one of them being the said local ad with local_ad_flag=yes from two different advertiser_id; r) learn the stb on the 1st website visit by associating the ip_address with the one stb_id and creating one record in the stbs_learned table, with an expiration_time set equal to the website_visit_time of the said 1st visit, based on an ad_id associated to a content_id and delivered to a wireless stb_id that shares the same said ip_address for both tv viewing and computer usage in the household, and a visit by the user from the same said ip_address to the said ppwv advertiser's url within a pre-determined time period after the said ad run, by ensuring that the said 1st website visit is from the same said ip_address as that present in the one and only one record of the said ads_viewed table; s) raise one or more leads for the ads viewed for the said 1st and/or 2nd website visits or online/mobile sale transactions to the said ads_server when a said stb is learned or when the one or more subsequent website visits or online/mobile sale transactions is applied from an already learned said stb stb if the website visits came from the same said ip_address and optionally the same unique_carrier_user_id (applies to mobile devices), based on the earliest timestamp of one of the records of the said ads_viewed table while ensuring that the number of leads for the said stb_id is less than or equal to the number of ad impressions and that there is no more than one lead for an impression of the ad by verifying that the said record of the ads_viewed table is not already present in the leads_raised table; and t) create one or more records in the ppwv_charges table with the lead fee and revenue share received from the said ads server; and facilitating the viewing of the roi report by one or more authorized employees of the said mso and one or more said ppwv advertisers comprises a tv data server.

16. The pay-per-website visit ad system in accordance with claim 1, wherein said means for storing one or more contents viewed by the said one or more stb_id, including the time of viewing and the view_source like linear tv, time-shifted, or video-on-demand (vod) comprises a viewing_data.

17. The pay-per-website visit ad system in accordance with claim 1, wherein said means for storing one or more ppwv ads viewed through stbs by one or more users as part of one or more contents, each with a pre-determined expiration time comprises an ads_viewed.

18. The pay-per-website visit ad system in accordance with claim 1, wherein said means for storing the said one or more ppwv ads broadcast to all the said stbs as part of the said one or more contents comprises an ad_runs.

19. The pay-per-website visit ad system in accordance with claim 1, wherein said means for storing one or more unique users visiting the website or making a sale transaction from desktop and mobile devices, as reported by the one or more ppwv advertisers' web servers comprises a website_visits.

20. The pay-per-website visit ad system in accordance with claim 1, wherein said means for storing one or more 1st website visits or sale transactions as determined by the correlation logic; and updating the expiration time of the said one or more records of the first_visit_history table when the said one or more records of viewing_data are received from the service provider server for the matching stb_id comprises a first_visit_history.

21. The pay-per-website visit ad system in accordance with claim 1, wherein said means for storing one or more stbs learned against the said one or more ip_address and unique_carrier_user_id per the said correlation logic; updating one or more existing records for the time_of_last_visit when the one or more new website visits or online/mobile sale transactions are received based on a match of the ip_address and unique_carrier_user_id values in the stbs_learned table comprises a stbs_learned.

22. The pay-per-website visit ad system in accordance with claim 1, wherein said means for storing one or more leads raised by the said correlation logic so as to ensure that no more than no more than one lead is raised for an impression of the ppwv ad for the said stb_id served by the said mso comprises a leads_raised.

23. The pay-per-website visit ad system in accordance with claim 1, wherein said means for storing one or more valid leads, associated with the said one or more stb_id as well as the said one or more ip_address and unique_carrier_user_id for the said one or more website visits or online/mobile sale transactions per the said correlation logic comprises a ppwv_charges.

24. A pay-per-website visit ad system for providing proof that the website visit is associated to a tv ad and in an anonymous manner, comprising:
an user, for viewing one or more contents, each of which contains one or more tv ads, delivered to a stb; and making a website visit to either gather information on product/service advertised or make a purchase;
an advertiser, for creating an account in the service provider's ads server; creating one or more ppwv campaigns under the account; getting charged a lead fee for one or more website visits or online/mobile purchase transactions based on the one or more ads that the user viewed as part of the one or more tv programs per the correlation logic; and having the privilege to view the roi report;
an ads server, for creating one or more pay-per-website visit advertisers consisting of name, address, city, state, zip code, and directory number (dn); maintaining one or more pay-per-website visit (ppwv) tv ads configured by the advertiser; sending one or more ppwv advertisers and their respective tv ads details to the tv data server; determining the lead fee applicable to a website visit or online/mobile sale transaction as reported by the tv data server; and sharing the lead fee with the partner;
a service provider server, for receiving relevant one or more tv contents and associated ads from the serving system and delivering them to one or more set-top boxes (stbs); sending one or more stbs information consisting of stb id, ip address (optional, newer stbs have wireless capability), mso id, city, state, and zip code to tv data server; passing one or more viewing data consisting of stb id, content id, view source (l=linear tv, t=time-shifted, and v=vod), status (b=begin viewing, e=end viewing), and timestamp to tv data server; and sending one or more ad runs information consisting of ad id, content id, and timestamp to tv data server;
a stations, for storing one or more stations that are served by the said mso that maybe affiliated to one or more networks having one or more channel numbers;
a stbs, for storing one or more stbs served by the said mso, including those that are to be dropped because of subscriber disconnects from the said mso, with an ip_address if the said stb is wireless capable, where the ip_address is assigned by the internet service provider (isp) of the subscriber and is the same for tv viewing and internet browsing;
a contents, for storing one or more contents broadcast by the said mso via the said one or more stations having the said one or more channel numbers;
an ad_zones, for storing one or more zones under the said one or more dmas, where each zone contains one or more zip codes;
a zip_by_dma, for storing the said one or more zip codes within the said one or more dmas;
an ip2locations, for storing one or more ip_address against the city, state, and zip_code;
a ppwv_advertisers, for storing one or more ppwv advertisers' information that signed up with the ads server running at a service provider;
a ppwv_ads, for storing one or more ppwv ads that are scheduled to run as part of the said one or more contents with the content_id, advertiser_id, duration, ad_title, advertiser_url, and final_ad_broadcast_time as configured by the one or more ppwv advertisers in the said ads server;
an ad_target_areas, for storing one or more target areas for the said one or more ppwv ads that are broadcast as part of the said one or more contents within the said one or more dmas, each of which contains the said one or more zones, which in turn contain the said one or more zip codes;
a tv data server, for receiving the mso information from the service provider server and storing the information in the msos table; receiving one or more stations served by the said mso from the said service provider server and storing the information in the stations table; receiving one or more ad zones served by the said mso from the said service provider server and storing the information in the ad_zones table; receiving one or more stbs, including additions and deletions, served by the said mso from the said service provider server and storing the information in the stbs table; receiving one or more ppwv advertisers from an ads server and storing the information in the ppwv_advertisers table; receiving one or more ppwv ads, and one or more zone ids related to the said one or more ppwv advertisers from the said ads server and storing the information in the ppwv_ads and ad_target_areas tables, respectively; receiving one or more program-related contents that are broadcast through the cable tv network or satellite tv network from the said service provider server and storing the information in the contents table; receiving one or more viewing data information relating to the said one or more contents delivered to one or more users' said stbs by the said mso from the said service provider server and storing the information in the viewing_data table; receiving one or more ad runs information relating to the said one or more ppwv ads by the said mso from the said service provider server and storing the information in the ad_runs table; determining and creating one or more ads viewed relating to the said one or more ppwv ads that are watched as part of the said one or more contents and delivered to the said one or more stbs by the said mso from the said service provider server and storing the information in the ads_viewed table; receiving one or more users' online and mobile website visits information from one or more ppwv advertisers' web servers and storing the information in the website_visits table; executing correlation logic to a) determine the records containing city, state, and zip_code from the ip2locations table for the one or more ip_address stored in the said website_visits table, provided the website visit time in the said records is greater than or equal to the ad run time and less than or equal to the expiration time in the said one or more records of the ads_viewed table; b) for each record in the said website_visits table, determine one or more dma_code from the zip_by_dma table based on the said zip_code in the ip2locations record; c) generate a list of zip codes that are within a pre-determined radius of the said zip_code in the said ip2locations record; d) determine one or more ppwv ads from the said ppwv_ads table for the said one or more ppwv advertisers in active status and for the advertiser_url in the said website_visits record; e) determine further one or more ppwv ads that are broadcast within the said one or more zone_id in the said ad_target_areas table based on a match of the ad_id and content_id, as well as dma_code in the said ad_target_areas table vs. the dma_code found in the said zip_by_dma table; f) determine further the one or more said ppwv ads that are broadcast within the said one or more zip_code for the said one or more zone_id; g) determine further the one or more ppwv ads that are broadcast within the said one or more zip_code for the said one or more zone_id and within the list of the said zip_code in a pre-determined radius of the said zip_code in the said ip2locations record; h) determine further the count of unique said dma_code for the said zip_code in the said ip2locations record; i) determine further the count of unique said zone_id for the said one or more said ppwv ads that are broadcast within the one or more said zip_code for the one or more said zone_id and within the list of said zip_code in the pre-determined radius of the said zip_code in the said ip2locations record; j) determine further that the unique count of the said dma_code and the unique count of the said zone_id constitute a local ad based on the count of the unique said dma_code being less than or equal to a pre-determined number of dma zones and the unique count of the said zone_id being less than or equal to a pre-determined number of ad zones; k) determine further that the said one or more ppwv ads delivered to the one or more stb_id are within the said one or more zip_code and that the said zip_code for the said one or more zone_id are within the said list of zip_code in a pre-determined radius of the said zip_code in the said ip2locations record and that the said website visit occurred within a pre-determined time period of the said ad runs and that a lead fee has not been already been raised for the one or more records in the said ads_viewed table; l) determine further that the resulting said one or more ppwv ads is due to the 1st website visit from the said ip_address; m) store the resulting said one or more ppwv ads in the first_visit_histories table; n) update the existing one or more records in the said first_transaction_histories table with expiration_time equal to the timestamp of the said one or more records of the said viewing_data records+a pre-determined time period, if the said stb_id matches between the said one or more viewing_data and first_visit_histories tables' records; o) learn the stb on the 2nd website visit by associating the said ip_address and optionally unique_carrier_user_id (applies only to mobile devices) with the said one or more stb_id and creating one or more records in the stbs_learned table, each with an expiration_time set equal to the website_visit_time of the said 2nd visit, based on two different ad_id, one of which is the said local ad, delivered to the same said stb_id from two different content_id and two different advertisers, and two visits by a user from the same said ip_address and optionally the same unique_carrier_user_id (applies to mobile devices) to the respective urls, both visits within a pre-determined time period after the respective said ad runs, by ensuring that the said 2nd website visit is from the same said ip_address as that present in the one or more records of the said first_visit_histories table, and the said records of the first_transaction_history table containing the same said stb_id value as that present in the one or more records of the said ads_viewed table, and the said records of the first_transaction_history table and the said one or more records of the ads_viewed table containing two different content_id and two different ad_id values with one of them being the said local ad with local_ad_flag=yes from two different advertiser_id; p) learn the stb on the 2nd website visit by associating the said ip_address and optionally unique_carrier_user_id (applies only to mobile devices) with the said one or more stb_id and creating one or more records in the stbs_learned table, each with an expiration_time set equal to the website_visit_time of the said 2nd visit, based on two different ad_id, one of which is the said local ad, delivered to the same said stb_id from two different content_id and the same said ppwv advertiser, and two visits by a user from the same said ip_address and optionally the same unique_carrier_user_id (applies to mobile devices) to the respective urls, both visits within a pre-determined time period after the respective said ad runs, by ensuring that the said 2nd website visit is from the same said ip_address as that present in the said one or more records of the first_visit_histories table, and the said records of the first_transaction_history table containing the same said stb_id value as that present in the said one or more records of the ads_viewed table, and the said records of the first_transaction_history table and the said one or more records of the ads_viewed table containing two different content_id and two different ad_id values with one of them being the said local ad with local_ad_flag=yes from the same advertiser_id; q) learn the stb on the 2nd website visit by associating the said ip_address and optionally unique_carrier_user_id (applies only to mobile devices) with the said one or more stb_id and creating the one or more records in the stbs_learned table, each with an expiration_time set equal to the website_visit_time of the said 2nd visit, based on two different ad_id that are at least a pre-determined time period apart in respect of their said ad run times, one of which is the said local ad, delivered to the same said stb_id from the same content_id and two different said ppwv advertisers, and two visits by a user from the same said ip_address and optionally the same unique_carrier_user_id (applies to mobile devices) to the respective urls, both visits within a pre-determined time period after the respective said ad runs, by ensuring that the said 2nd website visit is from the same said ip_address as that present in one or more records of the said first_visit_histories table, and the said records of the first_transaction_history table containing the same said stb_id value as that present in the said one or more records of the ads_viewed table, and the said records of the first_transaction_history table and the said one or more records of the ads_viewed table containing the same content_id and two different ad_id values with one of them being the said local ad with local_ad_flag=yes from two different advertiser_id; r) learn the stb on the 1st website visit by associating the ip_address with the one stb_id and creating one record in the stbs_learned table, with an expiration_time set equal to the website_visit_time of the said 1st visit, based on an ad_id associated to a content_id and delivered to a wireless stb_id that shares the same said ip_address for both tv viewing and computer usage in the household, and a visit by the user from the same said ip_address to the said ppwv advertiser's url within a pre-determined time period after the said ad run, by ensuring that the said 1st website visit is from the same said ip_address as that present in the one and only one record of the said ads_viewed table; s) raise one or more leads for the ads viewed for the said 1st and/or 2nd website visits or online/mobile sale transactions to the said ads_server when a said stb is learned or when the one or more subsequent website visits or online/mobile sale transactions is applied from an already learned said stb if the website visits came from the same said ip_address and optionally the same unique_carrier_user_id (applies to mobile devices), based on the earliest timestamp of one of the records of the said ads_viewed table while ensuring that the number of leads for the said stb_id is less than or equal to the number of ad impressions and that there is no more than one lead for an impression of the ad by verifying that the said record of the ads_viewed table is not already present in the leads_raised table; and t) create one or more records in the ppwv_charges table with the lead fee and revenue share received from the said ads server; and facilitating the viewing of the roi report by one or more authorized employees of the said mso and one or more said ppwv advertisers;
a viewing_data, for storing one or more contents viewed by the said one or more stb_id, including the time of viewing and the view_source like linear tv, time-shifted, or video-on-demand (vod);
an ads_viewed, for storing one or more ppwv ads viewed through stbs by one or more users as part of one or more contents, each with a pre-determined expiration time;
an ad_runs, for storing the said one or more ppwv ads broadcast to all the said stbs as part of the said one or more contents;
a website_visits, for storing one or more unique users visiting the website or making a sale transaction from desktop and mobile devices, as reported by the one or more ppwv advertisers' web servers;
a first_visit_history, for storing one or more 1st website visits or sale transactions as determined by the correlation logic; and updating the expiration time of the said one or more records of the first_visit_history table when the said one or more records of viewing_data are received from the service provider server for the matching stb_id;
a stbs_learned, for storing one or more stbs learned against the said one or more ip_address and unique_carrier_user_id per the said correlation logic; updating one or more existing records for the time_of_last_visit when the one or more new website visits or online/mobile sale transactions are received based on a match of the ip_address and unique_carrier_user_id values in the stbs_learned table;
a leads_raised, for storing one or more leads raised by the said correlation logic so as to ensure that no more than no more than one lead is raised for an impression of the ppwv ad for the said stb_id served by the said mso; and
a ppwv_charges, for storing one or more valid leads, associated with the said one or more stb_id as well as the said one or more ip_address and unique_carrier_user_id for the said one or more website visits or online/mobile sale transactions per the said correlation logic.

25. A pay-per-website visit ad system for providing proof that the website visit is associated to a tv ad and in an anonymous manner, comprising:
an user, for viewing one or more contents, each of which contains one or more tv ads, delivered to a stb; and making a website visit to either gather information on product/service advertised or make a purchase;
an advertiser, for creating an account in the service provider's ads server; creating one or more ppwv campaigns under the account; getting charged a lead fee for one or more website visits or online/mobile purchase transactions based on the one or more ads that the user viewed as part of the one or more tv programs per the correlation logic; and having the privilege to view the roi report;
an ads server, for creating one or more pay-per-website visit advertisers consisting of name, address, city, state, zip code, and directory number (dn); maintaining one or more pay-per-website visit (ppwv) tv ads configured by the advertiser; sending one or more ppwv advertisers and their respective tv ads details to the tv data server; determining the lead fee applicable to a website visit or online/mobile sale transaction as reported by the tv data server; and sharing the lead fee with the partner;
a service provider server, for receiving relevant one or more tv contents and associated ads from the serving system and delivering them to one or more set-top boxes (stbs); sending one or more stbs information consisting of stb id, ip address (optional, newer stbs have wireless capability), mso id, city, state, and zip code to tv data server; passing one or more viewing data consisting of stb id, content id, view source (l=linear tv, t=time-shifted, and v=vod), status (b=begin viewing, e=end viewing), and timestamp to tv data server; and sending one or more ad runs information consisting of ad id, content id, and timestamp to tv data server;
a stations, for storing one or more stations that are served by the said mso that maybe affiliated to one or more networks having one or more channel numbers;
a stbs, for storing one or more stbs served by the said mso, including those that are to be dropped because of subscriber disconnects from the said mso, with an ip_address if the said stb is wireless capable, where the ip_address is assigned by the internet service provider (isp) of the subscriber and is the same for tv viewing and internet browsing;
a contents, for storing one or more contents broadcast by the said mso via the said one or more stations having the said one or more channel numbers;
an ad_zones, for storing one or more zones under the said one or more dmas, where each zone contains one or more zip codes;
a zip_by_dma, for storing the said one or more zip codes within the said one or more dmas;
an ip2locations, for storing one or more ip_address against the city, state, and zip_code;
a ppwv_advertisers, for storing one or more ppwv advertisers' information that signed up with the ads server running at a service provider;
a ppwv_ads, for storing one or more ppwv ads that are scheduled to run as part of the said one or more contents with the content_id, advertiser_id, duration, ad_title, advertiser_url, and final_ad_broadcast_time as configured by the one or more ppwv advertisers in the said ads server;
an ad_target_areas, for storing one or more target areas for the said one or more ppwv ads that are broadcast as part of the said one or more contents within the said one or more dmas, each of which contains the said one or more zones, which in turn contain the said one or more zip codes;
a tv data server, for receiving the mso information from the service provider server and storing the information in the msos table; receiving one or more stations served by the said mso from the said service provider server and storing the information in the stations table; receiving one or more ad zones served by the said mso from the said service provider server and storing the information in the ad_zones table; receiving one or more stbs, including additions and deletions, served by the said mso from the said service provider server and storing the information in the stbs table; receiving one or more ppwv advertisers from an ads server and storing the information in the ppwv_advertisers table; receiving one or more ppwv ads, and one or more zone ids related to the said one or more ppwv advertisers from the said ads server and storing the information in the ppwv_ads and ad_target_areas tables, respectively; receiving one or more program-related contents that are broadcast through the cable tv network or satellite tv network from the said service provider server and storing the information in the contents table; receiving one or more viewing data information relating to the said one or more contents delivered to one or more users' said stbs by the said mso from the said service provider server and storing the information in the viewing_data table; receiving one or more ad runs information relating to the said one or more ppwv ads by the said mso from the said service provider server and storing the information in the ad_runs table; determining and creating one or more ads viewed relating to the said one or more ppwv ads that are watched as part of the said one or more contents and delivered to the said one or more stbs by the said mso from the said service provider server and storing the information in the ads_viewed table; receiving one or more users' online and mobile website visits information from one or more ppwv advertisers' web servers and storing the information in the website_visits table; executing correlation logic to a) determine the records containing city, state, and zip_code from the ip2locations table for the one or more ip_address stored in the said website_visits table, provided the website visit time in the said records is greater than or equal to the ad run time and less than or equal to the expiration time in the said one or more records of the ads_viewed table; b) for each record in the said website_visits table, determine one or more dma_code from the zip_by_dma table based on the said zip_code in the ip2locations record; c) generate a list of zip codes that are within a pre-determined radius of the said zip_code in the said ip2locations record; d) determine one or more ppwv ads from the said ppwv_ads table for the said one or more ppwv advertisers in active status and for the advertiser_url in the said website_visits record; e) determine further one or more ppwv ads that are broadcast within the said one or more zone_id in the said ad_target_areas table based on a match of the ad_id and content_id, as well as dma_code in the said ad_target_areas table vs. the dma_code found in the said zip_by_dma table; f) determine further the one or more said ppwv ads that are broadcast within the said one or more zip_code for the said one or more zone_id; g) determine further the one or more ppwv ads that are broadcast within the said one or more zip_code for the said one or more zone_id and within the list of the said zip_code in a pre-determined radius of the said zip_code in the said ip2locations record; h) determine further the count of unique said dma_code for the said zip_code in the said ip2locations record; i) determine further the count of unique said zone_id for the said one or more said ppwv ads that are broadcast within the one or more said zip_code for the one or more said zone_id and within the list of said zip_code in the pre-determined radius of the said zip_code in the said ip2locations record; j) determine further that the unique count of the said dma_code and the unique count of the said zone_id constitute a local ad based on the count of the unique said dma_code being less than or equal to a pre-determined number of dma zones and the unique count of the said zone_id being less than or equal to a pre-determined number of ad zones; k) determine further that the said one or more ppwv ads delivered to the one or more stb_id are within the said one or more zip_code and that the said zip_code for the said one or more zone_id are within the said list of zip_code in a pre-determined radius of the said zip_code in the said ip2locations record and that the said website visit occurred within a pre-determined time period of the said ad runs and that a lead fee has not been already been raised for the one or more records in the said ads_viewed table; l) determine further that the resulting said one or more ppwv ads is due to the 1st website visit from the said ip_address; m) store the resulting said one or more ppwv ads in the first_visit_histories table; n) update the existing one or more records in the said first_transaction_histories table with expiration_time equal to the timestamp of the said one or more records of the said viewing_data records+a pre-determined time period, if the said stb_id matches between the said one or more viewing_data and first_visit_histories tables' records; o) learn the stb on the 2nd website visit by associating the said ip_address and optionally unique_carrier_user_id (applies only to mobile devices) with the said one or more stb_id and creating one or more records in the stbs_learned table, each with an expiration_time set equal to the website_visit_time of the said 2nd visit, based on two different ad_id, one of which is the said local ad, delivered to the same said stb_id from two different content_id and two different advertisers, and two visits by a user from the same said ip_address and optionally the same unique_carrier_user_id (applies to mobile devices) to the respective urls, both visits within a pre-determined time period after the respective said ad runs, by ensuring that the said 2nd website visit is from the same said ip_address as that present in the one or more records of the said first_visit_histories table, and the said records of the first_transaction_history table containing the same said stb_id value as that present in the one or more records of the said ads_viewed table, and the said records of the first_transaction_history table and the said one or more records of the ads_viewed table containing two different content_id and two different ad_id values with one of them being the said local ad with local_ad_flag=yes from two different advertiser_id; p) learn the stb on the 2nd website visit by associating the said ip_address and optionally unique_carrier_user_id (applies only to mobile devices) with the said one or more stb_id and creating one or more records in the stbs_learned table, each with an expiration_time set equal to the website_visit_time of the said 2nd visit, based on two different ad_id, one of which is the said local ad, delivered to the same said stb_id from two different content_id and the same said ppwv advertiser, and two visits by a user from the same said ip_address and optionally the same unique_carrier_user_id (applies to mobile devices) to the respective urls, both visits within a pre-determined time period after the respective said ad runs, by ensuring that the said 2nd website visit is from the same said ip_address as that present in the said one or more records of the first_visit_histories table, and the said records of the first_transaction_history table containing the same said stb_id value as that present in the said one or more records of the ads_viewed table, and the said records of the first_transaction_history table and the said one or more records of the ads_viewed table containing two different content_id and two different ad_id values with one of them being the said local ad with local_ad_flag=yes from the same advertiser_id; q) learn the stb on the 2nd website visit by associating the said ip_address and optionally unique_carrier_user_id (applies only to mobile devices) with the said one or more stb_id and creating the one or more records in the stbs_learned table, each with an expiration_time set equal to the website_visit_time of the said 2nd visit, based on two different ad_id that are at least a pre-determined time period apart in respect of their said ad run times, one of which is the said local ad, delivered to the same said stb_id from the same content_id and two different said ppwv advertisers, and two visits by a user from the same said ip_address and optionally the same unique_carrier_user_id (applies to mobile devices) to the respective urls, both visits within a pre-determined time period after the respective said ad runs, by ensuring that the said 2nd website visit is from the same said ip_address as that present in one or more records of the said first_visit_histories table, and the said records of the first_transaction_history table containing the same said stb_id value as that present in the said one or more records of the ads_viewed table, and the said records of the first_transaction_history table and the said one or more records of the ads_viewed table containing the same content_id and two different ad_id values with one of them being the said local ad with local_ad_flag=yes from two different advertiser_id; r) learn the stb on the 1st website visit by associating the ip_address with the one stb_id and creating one record in the stbs_learned table, with an expiration_time set equal to the website_visit_time of the said 1st visit, based on an ad_id associated to a content_id and delivered to a wireless stb_id that shares the same said ip_address for both tv viewing and computer usage in the household, and a visit by the user from the same said ip_address to the said ppwv advertiser's url within a pre-determined time period after the said ad run, by ensuring that the said 1st website visit is from the same said ip_address as that present in the one and only one record of the said ads_viewed table; s) raise one or more leads for the ads viewed for the said 1st and/or 2nd website visits or online/mobile sale transactions to the said ads_server when a said stb is learned or when the one or more subsequent website visits or online/mobile sale transactions is applied from an already learned said stb if the website visits came from the same said ip_address and optionally the same unique_carrier_user_id (applies to mobile devices), based on the earliest timestamp of one of the records of the said ads_viewed table while ensuring that the number of leads for the said stb_id is less than or equal to the number of ad impressions and that there is no more than one lead for an impression of the ad by verifying that the said record of the ads_viewed table is not already present in the leads_raised table; and t) create one or more records in the ppwv_charges table with the lead fee and revenue share received from the said ads server; and facilitating the viewing of the roi report by one or more authorized employees of the said mso and one or more said ppwv advertisers;
a viewing_data, for storing one or more contents viewed by the said one or more stb_id, including the time of viewing and the view_source like linear tv, time-shifted, or video-on-demand (vod);
an ads_viewed, for storing one or more ppwv ads viewed through stbs by one or more users as part of one or more contents, each with a pre-determined expiration time;
an ad_runs, for storing the said one or more ppwv ads broadcast to all the said stbs as part of the said one or more contents;
a website_visits, for storing one or more unique users visiting the website or making a sale transaction from desktop and mobile devices, as reported by the one or more ppwv advertisers' web servers;
a first_visit_history, for storing one or more 1st website visits or sale transactions as determined by the correlation logic; and updating the expiration time of the said one or more records of the first_visit_history table when the said one or more records of viewing_data are received from the service provider server for the matching stb_id;
a stbs_learned, for storing one or more stbs learned against the said one or more ip_address and unique_carrier_user_id per the said correlation logic; updating one or more existing records for the time_of_last_visit when the one or more new website visits or online/mobile sale transactions are received based on a match of the ip_address and unique_carrier_user_id values in the stbs_learned table;
a leads_raised, for storing one or more leads raised by the said correlation logic so as to ensure that no more than no more than one lead is raised for an impression of the ppwv ad for the said stb_id served by the said mso; and
a ppwv_charges, for storing one or more valid leads, associated with the said one or more stb_id as well as the said one or more ip_address and unique_carrier_user_id for the said one or more website visits or online/mobile sale transactions per the said correlation logic.
